(19) United States
(12) Patent Application Publication
(10) Pub. No.: US 2017/0036372 A1
(43) Pub. Date: Feb. 9, 2017

(54) MODULATION OF THIXOTROPIC PROPERTIES OF CEMENTITIOUS MATERIALS

(71) Applicant: CARBONCURE TECHNOLOGIES INC., Dartmouth (CA)

(72) Inventors: Paul J. SANDBERG, Beverly, MA (US); George Sean MONKMAN, Montreal (CA); Kevin CAIL, Sarasota, FL (US); Mark McDONALD, Halifax (CA); Dean Paul FORGERON, White's Lake (CA); Joshua Jeremy BROWN, Lower Sackville (CA)

(21) Appl. No.: 15/304,208

(22) PCT Filed: Apr. 16, 2015
(86) PCT No.: PCT/CA2015/050318

§ 371 Date: Oct. 14, 2016

Related U.S. Application Data
(63) Continuation of application No. PCT/CA2014/050611, filed on Jun. 25, 2014.
(60) Provisional application No. 61/992,089, filed on May 12, 2014.
(60) Provisional application No. 62/083,784, filed on Nov. 24, 2014.
(60) Provisional application No. 62/086,024, filed on Dec. 1, 2014.
(60) Provisional application No. 62/096,018, filed on Dec. 23, 2014.

(30) Foreign Application Priority Data
Jun. 25, 2014 (CA) PCT/CA2014/050611

(51) Int. Cl. B28C 7/02; C04B 40/02; B28B 1/26; B28C 5/46; B28B 1/00

(52) U.S. Cl. CPC B28C 7/024; B28C 5/46; B28B 1/001; B28B 1/26; C04B 40/0231

(57) ABSTRACT

The invention provides methods and compositions for increasing stiffness or rate of stiffening of concrete mixes by carbonation of the mix, preferably while viscosity remains at a level suitable for the intended use of the concrete mix.

### CROSS REFERENCE TO RELATED APPLICATIONS

This application claims priority to U.S. Provisional Patent Applications 61/980,505, filed Apr. 16, 2014; 61/992,089, filed May 12, 2014; 62/086,024, filed Dec. 1, 2014; 62/083,784, filed Nov. 24, 2014, and 62/096,018, filed Dec. 23, 2014, and to PCT/CA 2014050611, filed Jun. 25, 2014; each of which is entirely incorporated herein by reference.

### BACKGROUND OF THE INVENTION

Many applications of cementitious materials require both that the material be poured or otherwise placed, for example into a container such as a mold, and then be allowed to be free standing, without deformation or destruction of the material. The properties that are compatible with pouring and otherwise placing the cementitious material are not necessarily the same as those required for the material to possess sufficient structural integrity for later steps in the process without first setting or otherwise hardening. It would be advantageous to produce cementitious material with thixotropic properties such that it could be placed but then be allowed to be free standing or otherwise used as desired as quickly as possible.

### SUMMARY OF THE INVENTION

In certain aspects, the invention provides methods. In certain embodiments, the invention provides a method of carbonating a wet concrete mix having a mix design and to be used in an operation to produce a carbonated wet concrete mix, wherein the carbonated concrete mix has a desired stiffness and/or rate of stiffening that is greater than a stiffness and/or rate of stiffening of an uncarbonated concrete mix of the same mix design, comprising contacting the wet concrete mix with a pre-determined dose of carbon dioxide, for example, during mixing, where the pre-determined dose of carbon dioxide is known or predicted to produce the desired stiffness and/or rate of stiffening under the conditions of the mixing and/or operation. The pre-determined dose can based on the mix design of the wet concrete mix, for example, based on the cement type in the mix design, one or more admixtures used in the mix design, or a combination thereof. The pre-determined dose can be based on a test comprising (i) contacting a first sample of the concrete mix or components of the concrete mix with a first test dose of carbon dioxide to produce a first test carbonated concrete mix or components of the concrete mix; (ii) determining a stiffness and/or rate of stiffening of the first test carbonated concrete mix or components of the concrete mix; and (iii) determining the pre-determined dose of carbon dioxide based at least in part on the first test dose and the stiffness and/or rate of stiffening of the first test carbonated concrete mix or components of the concrete mix. Step (i) can further comprise contacting a second sample of the concrete mix or components of the concrete mix with a second test dose of carbon dioxide to produce a second test carbonated concrete mix or components of the concrete mix, wherein the second test dose is different from the first test dose; step (ii) can further comprise determining a stiffness and/or rate of stiffening of the second test carbonated concrete mix or components of the concrete mix; and step (iii) can comprise determining the pre-determined dose of carbon dioxide based at least in part on the first test dose and the stiffness and/or rate of stiffening of the first test carbonated concrete mix or components of the concrete mix and the second test dose and the stiffness and/or rate of stiffening of the second test carbonated concrete mix or components of the concrete mix. In addition, step (i) can further comprise contacting a third sample of the concrete mix or components of the concrete mix with a third test dose of carbon dioxide to produce a third test carbonated concrete mix or components of the concrete mix, wherein the third test dose is different from the first and second test doses; step (ii) can further comprise determining a stiffness and/or rate of stiffening of the third test carbonated concrete mix or components of the concrete mix; and step (iii) can comprise determining the pre-determined dose of carbon dioxide based at least in part on the first test dose and the stiffness and/or rate of stiffening of the first test carbonated concrete mix or components of the concrete mix, the second test dose and the stiffness and/or rate of stiffening of the second test carbonated concrete mix or components of the concrete mix, and the third test dose and the stiffness and/or rate of stiffening of the third test carbonated concrete mix or components of the concrete mix. The pre-determined dose can also be based, at least in part, on comparing an efficiency of carbonation of the test sample or samples to an expected efficiency of carbonation when the pre-determined dose is contacted with the wet concrete mix during mixing. The stiffness or rate of stiffening of the carbonated concrete mix can be at least 5% greater than that of the uncarbonated concrete mix. The testing can further include determining a stiffness and/or rate of stiffening of a sample of uncarbonated concrete mix, and comparing the stiffness and/or rate of stiffening of the carbonated samples to the uncarbonated sample. The contacting of the test sample or samples with carbon dioxide can be conducted at a temperature that is within 3° C. of the expected temperature at which the wet concrete mix will be contacted with the pre-determined dose of carbon dioxide. The rate of stiffening can be determined by measuring stiffness of the concrete mix at a plurality of time points, where the temperature at one or more of the plurality of time points is within 3° C. of the expected temperature at which the wet concrete mix will be used in the operation at the one or more time points. In certain embodiments, the operation is a precast operation. In certain embodiments, the operation is a slip form operation. In certain embodiments, the operation is an operation in which concrete is poured into construction forms. In certain embodiments, the operation is a 3D concrete printing operation.

In another aspect, the invention provides systems. In certain embodiments, the invention provides a system comprising (i) a concrete mixing facility in which a concrete mix is carbonated by contacting the mix with a pre-determined dose of carbon dioxide to produce a carbonated concrete mix that has a greater stiffness or rate of stiffening compared to the same concrete mix if it is not carbonated, where the concrete mix is for use in an operation; (ii) a testing facility in which the pre-determined dose of carbon dioxide is determined; and (iii) a communication system to communicate the pre-determined dose of carbon dioxide determined in the testing facility to the concrete mixing facility. In certain embodiments, the operation is a precast operation, a slip form operation, an operation in which concrete is poured into fixed forms, or a 3D concrete printing operation. In certain embodiments, the concrete mixing facility and the testing facility are different facilities. In certain embodiments, the concrete mixing facility comprises a concrete mixer and one or more sources of one or more concrete materials comprising one or more of cement, aggregate, and water. In certain embodiments, the test facility comprises a test concrete mixing apparatus, a carbon dioxide delivering and metering apparatus, and a concrete stiffness test apparatus. In certain embodiments, the test facility further comprises a concrete viscosity test apparatus.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows slump relative to an uncarbonated control for 20 different types of cement, which were carbonated at various levels.

FIG. 2 shows workability relative to an uncarbonated control for 20 different types of cement, which were carbonated at various levels.

FIG. 3 shows slump for concrete mix carbonated at two different doses of carbon dioxide compared to uncarbonated control, at various levels of water addition.

FIG. 4 shows slump for carbonated concrete mix vs. uncarbonated concrete mix over time.

FIG. 5 shows slump for mortar mixes carbonated at different levels of carbonation, compared to uncarbonated control, where the mixes were prepared and carbonated at 25° C.

FIG. 6 shows slump for mortar mixes carbonated at different levels of carbonation, compared to uncarbonated control, where the mixes were prepared and carbonated at 15° C.

FIG. 7 shows slump for mortar mixes carbonated at different levels of carbonation, compared to uncarbonated control, where the mixes were prepared and carbonated at 7° C.

FIG. 8 shows yield stress of carbonated and uncarbonated mortar mix containing Illinois Product cement, without admixture and with one or two doses of admixture.

FIG. 9 shows viscosity of carbonated and uncarbonated mortar mix containing Illinois Product cement, without admixture and with one or two doses of admixture.

FIG. 10 shows yield stress of carbonated and uncarbonated mortar mix containing Holcim cement, without admixture and with one or two doses of admixture.

FIG. 11 shows viscosity of carbonated and uncarbonated mortar mix containing Holcim cement, without admixture and with one or two doses of admixture.

FIG. 12 shows yield stress for uncarbonated (control) and carbonated mortar mixes at various degrees of carbonation immediately after carbonation and before addition of admixture.

FIG. 13 shows dose of admixture for uncarbonated (control) and carbonated mortar mixes at various degrees of carbonation; the doses for the carbonated mortar mixes were those required to bring the torque of these mixes to the same torque as the uncarbonated control. Mixes are the same as shown in FIG. 12.

FIG. 14 shows yield stress increase over time for uncarbonated (control) and carbonated mortar mixes at various degrees of carbonation, starting with addition of admixture to bring all mixes to the same torque. Mixes are the same as shown in FIG. 12.

FIG. 15 shows viscosity over time for uncarbonated (control) and carbonated mortar mixes at various degrees of carbonation, before and after addition of admixture to bring all mixes to the same torque. Mixes are the same as shown in FIG. 12.

FIG. 16 shows yield stress for uncarbonated (control) and carbonated mortar mixes containing St. Mary's Bowmanville cement at various degrees of carbonation immediately after carbonation and before addition of admixture.

FIG. 17 shows yield stress increase over time for uncarbonated (control) and carbonated mortar mixes containing St. Mary's Bowmanville cement at various degrees of carbonation, starting with addition of the same dose of admixture to all mixes. Mixes are the same as shown in FIG. 16.

FIG. 18 shows viscosity over time for uncarbonated (control) and carbonated mortar mixes containing St. Mary's Bowmanville cement at various degrees of carbonation, before and after addition of the same dose of admixture to all mixes. Mixes are the same as shown in FIG. 16.

FIG. 19 shows yield stress for uncarbonated (control) and carbonated mortar mixes containing Lafarge Brookfield cement at various degrees of carbonation immediately after carbonation and before addition of admixture.

FIG. 20 shows yield stress increase over time for uncarbonated (control) and carbonated mortar mixes containing Lafarge Brookfield cement at various degrees of carbonation, starting with addition of the same dose of admixture to all mixes. Mixes are the same as shown in FIG. 19.

FIG. 21 shows viscosity over time for uncarbonated (control) and carbonated mortar mixes containing Lafarge Brookfield cement at various degrees of carbonation, before and after addition of the same dose of admixture to all mixes. Mixes are the same as shown in FIG. 19.

### DETAILED DESCRIPTION OF THE INVENTION

The invention provides methods and compositions related to modifying the thixotropic properties of a cementitious mixture using carbon dioxide.

Cementitious mixtures, such as concrete, often are required to have two seemingly contradictory properties: they must possess sufficient flowability to be placed in the desired location and configuration, often in a mold or form, but it is then desired that the cementitious mixture, once placed, be able to be free standing without significant deformation or destruction of integrity as quickly as possible. In some cases, e.g., casting of precast concrete objects such as pipes, it is desired that the mold be removed almost immediately after the pouring of the concrete. In almost every case, the sooner the mold or form, if used, may be removed from the cementitious mixture, the more quickly work can proceed, offering greater efficiency and savings of time.

By carbonating a fresh cementitious mixture and, optionally, applying dispersant admixtures it is possible to produce a mixture that is functionally thixotropic (the viscosity increases in a state of rest and decreases when subjected to a shearing stress). The effect can also include increasing the static yield stress. An essentially non-thixotropic concrete mix can be made more thixotropic due to the reaction of the carbon dioxide with the cementitious material. Conventional admixtures are much less efficient in reducing the viscosity while maintaining a target dynamic yield stress. Thus the invention provides methods and compositions for modulating the thixotropic properties of cementitious mixtures.

“Cementitious mixture” or “cement mix,” as those terms are used interchangeably herein, includes a mix of a cement binder, e.g., a hydraulic cement, such as a Portland cement, and water; in some cases, “cementitious mixture” or “cement mix” includes a cement binder mixed with aggregate, such as a mortar (also termed a grout, depending on consistency), in which the aggregate is fine aggregate; or “concrete,” which includes a coarse aggregate. The invention is often described herein in terms of a concrete mix but it is understood that all cementitious mixtures may be encompassed by the invention. The cement binder may be a hydraulic or non-hydraulic cement, so long as it provides minerals, e.g. calcium, magnesium, sodium, and/or potassium compounds such as CaO, MgO, Na₂O, and/or K₂O that react with carbon dioxide to produce products that influence the thixotropic properties of the mix. An exemplary hydraulic cement useful in the invention is Portland cement. In general herein the invention is described in terms of hydraulic cement binder and hydraulic cement mixes, but it will be appreciated that the invention encompasses any cement mix, whether containing a hydraulic or non-hydraulic cement binder, so long as the cement binder is capable of forming products when exposed to carbon dioxide that affect the thixotropic properties, e.g., contains calcium, magnesium, sodium, and/or potassium compounds such as CaO, MgO, Na₂O, and/or K₂O. In certain embodiments, the invention provides methods, apparatus, and compositions for production of a cement mix (concrete) containing cement, such as Portland cement, treated with carbon dioxide. As used herein, the term “carbon dioxide” refers to carbon dioxide in a gas, solid, liquid, or supercritical state where the carbon dioxide is at a concentration greater than its concentration in the atmosphere; it will be appreciated that under ordinary conditions in the production of cement mixes (concrete mixes) the mix is exposed to atmospheric air, which contains minor amounts of carbon dioxide. The present invention is directed to production of cement mixes that are exposed to carbon dioxide at a concentration above atmospheric concentrations.

The cementitious mixture can be exposed to carbon dioxide at any suitable phase of the mix or placement operation, such as during mixing, pouring, and/or while in a conduit from a mixer to a pour site. See U.S. Pat. No. 8,845,940, U.S. patent application Ser. No. 14/429,308 and PCT Application No. PCT/CA2015/050118, all of which are incorporated herein by reference in their entireties. In general, an amount of carbon dioxide is used that modulates the thixotropic properties of the cementitious mixture to the desired degree. For example, in the case of a cementitious mixture, e.g., concrete, that is to be used in a precast operation or some ready-mix operations where the casting involves vibration or other movement of the mold or placement apparatus, sufficient carbon dioxide is added to the cementitious mixture so that, with the vibration or other movement, the cementitious mixture is distributed in the mold at a density that is adequate for the particular mold operation during placement, then, when vibration or other movement stops and the mold is removed, the cementitious mixture provides sufficient stiffness and structural strength that deformation and/or effects on the integrity of the cast object are within predetermined acceptable limits. It will be appreciated that the degree of flowability and subsequent integrity and strength will depend on the particular operation, and the amount of CO₂ used in a particular mix will be based on that particular operation. The amount of CO₂ used may be a predetermined amount, or it may be adjusted according to the mix properties during mixing, or a combination of both (e.g., CO₂ dose is adjusted during mixing but only within a certain predetermined range). In certain embodiments, CO₂ is added in the range of 0.01-0.05% by weight of cement (bwc), or 0.01-0.1, or 0.01-0.2, or 0.01-0.3, or 0.01-0.4, or 0.01-0.5, or 0.01-0.6, or 0.01-0.7, or 0.01-0.8, or 0.01-0.9, or 0.01-1.0, or 0.01-1.2, or 0.01-1.5, or 0.01-1.8, or 0.01-2.0, or 0.01-3.0% bwc, or 0.02-0.1, or 0.02-0.5, or 0.02-1.0, or 0.2-1.5, or 0.02-2.0, or 0.02-3.0, or 0.05-0.1, or 0.05-0.5, or 0.05-1.0, or 0.05-1.5, or 0.05-2.0, or 0.05-3.0% bwc. In certain embodiments, the rheology of a cementitious mixture is monitored during mixing and CO₂ is added until a desired rheology is reached. Methods and apparatus for monitoring rheology and other characteristics of a mixing cementitious mixture are described in U.S. patent application Ser. No. 14/429,308.

One or more admixtures may also be added to the cementitious mixture. These may be admixtures that impart desired properties to the cementitious mixture, as would be used without CO₂ addition. In certain embodiments one or more admixtures is added that further modulates the flowability or other characteristics of the cementitious mixture, in addition to the modulation already provided by the CO₂. Such admixtures include those described in U.S. patent application Ser. No. 14/429,308, such as carbohydrates or carbohydrate derivatives, e.g., fructose or sodium gluconate.

In certain embodiments, the invention provides methods and compositions for reducing the hydrostatic pressure in a cementitious mixture after placing by addition of carbon dioxide to the cementitious mixture before placing; e.g. reducing pressure of the concrete on the formwork (i.e. form pressure) and therefore reducing the cost of construction of formwork, especially for high rise pours and other large concrete pours. The dose of carbon dioxide used may be such that the hydrostatic pressure at a given location in the formwork is reduced by a certain percentage compared to the pressure without the carbon dioxide, or is within a certain percentage of a predetermined hydrostatic pressure. For example, the pressure may be reduced at least 1, 2, 5, 10, 20, 30, 40, 50, 60, or 70%, compared to the pressure without carbon dioxide, or may be within 1, 2, 5, 10, 20, 30, 40, 50, 60, or 70% of a predetermined desired pressure.

In certain embodiments, the invention provides methods and compositions for faster and more efficient slip form casting, as the carbonated mixture maintains a desirably low viscosity while flowing and a beneficially higher yield value soon after placing. Pumping and placement are improved. For example, in certain embodiments, a dose of carbon dioxide is used so that the speed at which the form may be moved may be increased by at least 1, 2, 5, 10, 20, 30, 40, 50, 60, or 70%, compared to the speed without carbon dioxide, while the integrity and strength of the construction object remains within allowable limits. This process can allow for faster and more efficient extrusion properties of pre-cast concrete sections, as the carbonated mixture maintains a desirably low viscosity while flowing and a beneficially higher viscosity soon after extrusion.

In certain embodiments, the invention provides methods and compositions for faster and more efficient 3-D printing of pre-cast concrete objects, as the carbonated mixture maintains a desirably low viscosity while flowing and a beneficially higher yield value soon after placement. This is beneficial for 3-D printing of the cementitious mixtures wherein layers of material are built up in succession to build a desired shape and the rate of accumulation can depend on the ability of the lower layers to withstand the load of the higher layers. For example, in certain embodiments, a dose of carbon dioxide is used so that the speed at which successive layers may be formed in 3D printing of concrete objects is increased by at least 1, 2, 5, 10, 20, 30, 40, 50, 60, or 70%, compared to the speed without carbon dioxide, while the integrity and strength of the construction object remains within allowable limits.

The desired carbonation level of a particular cementitious mixture to achieve a desired effect on the thixotropic properties of the mixture, e.g., increased stiffness at rest but acceptable viscosity with shearing stress, is high dependent on the mix design of the cementitious mixture. For simplicity, the process with be described in terms of a concrete mix, that is, a mix containing cement, aggregate, and water, but it will be understood that any cementitious mix is included in the description.

In addition, the actual dosage of carbon dioxide, its timing of delivery, and other factors, can be influenced by the conditions under which mixing of the carbon dioxide with the cementitious mixture occurs and/or the conditions under which the operation in which the concrete mix is used occur. Under some conditions mixing conditions, relatively low efficiencies of carbonation may be achieved and, to achieve a given level of carbonation, the dosage of carbon dioxide and/or other factors may need to be adjusted (increased) to account for the low efficiency, compared to mix conditions where relatively high efficiencies of carbonation are achieved. For example, in a closed or mostly closed mixer, such as used in a precast operation, a higher efficiency of carbonation may be achieved than in an open system, such as the drum of a ready-mix truck, and dosage may be adjusted accordingly depending on the mixer to achieve a given level of carbonation. Also, as detailed in the Examples, the temperature at which the carbonation occurs can have a marked effect on both the efficiency of carbonation and on the effects of carbonation at a given level on stiffness and, potentially, viscosity. See Example 5. Additionally, if a carbonated concrete mix is transported from the mix site to a job site, the temperature during transport and/or use can influence the stiffening and/or rate of stiffening and, potentially, viscosity of a given mix. Admixtures used in the mix design can also have an effect on the stiffness and viscosity achieved with a particular degree of carbonation. See Examples 6, 7, and 8.

Thus, in general, it is important to determine the particular mix design and/or conditions for a given operation to determine the dose of carbon dioxide to be delivered to have a desired effect on stiffness and/or rate of stiffening of the placed concrete, as well as, in some cases, the viscosity of the concrete. Characteristics that can influence the dose of carbon dioxide used in a particular operation include type of cement used, type and amount of admixture used, if any, temperature expected at the mixing site and, possibly, at the site at which the concrete will be placed in a mold or otherwise poured or shaped, approximate efficiency of carbonation in the mixer to be used, and any other characteristic found to influence the degree of carbonation of the concrete and/or the effect of a given dose of carbonation on the stiffness and/or viscosity of the concrete. It will be appreciated that in some operations increased stiffness and/or increased rate of stiffening of the poured concrete is of paramount concern, and viscosity of lesser concern. This includes operations in which vibration is used in conjunction with placement of the concrete, e.g., precast operations or operations at job sites where vibration may be used in conjunction with placement, such as in concrete paving operations. In other operations, it is desired to increase stiffness and/or rate of stiffening of the placed concrete but to keep viscosity at a level allowing placement of the concrete in the desired location and shape through simple pouring or pumping, without vibration of the concrete, which is the case in most ready-mix operations. In all cases the carbonated concrete mix must have sufficient flowability to be used under the conditions of the operation for which it is intended. In some cases, carbonated concrete mix at the desired level of stiffness and/or rate of stiffening may have sufficient flowability as is for the operation for which it is intended. In some cases, one or more additional components may be necessary in the concrete mix to achieve the necessary flowability for the intended operation, e.g., additional water and/or one or more admixtures.

Hence, in certain embodiments the invention provides a method of carbonating a wet concrete mix having a mix design and to be used in an operation to produce a carbonated wet concrete mix, where the carbonated concrete mix has a desired stiffness and/or rate of stiffening that is different than, e.g., greater than a stiffness and/or rate of stiffening of an uncarbonated concrete mix of the same mix design, that includes contacting the wet concrete mix with a pre-determined dose of carbon dioxide during mixing, wherein the pre-determined dose of carbon dioxide is known and/or predicted to produce the desired stiffness and/or rate of stiffening under the conditions of the mixing and/or operation. In some cases, the pre-determined dose may be based on the mix design of the wet concrete mix, for example, based on the type of cement used in the mix design, the type and amount of one or more admixtures used in the mix design, and the like. In such cases, generally the known effects of carbon dioxide on a mix design containing the component or components are used to determine the dose of carbon dioxide to be used in the actual mix operation. In certain embodiments, the dose of carbon dioxide may be adjusted according to conditions of the mixing setup and/or the operation in which the concrete mix is used; thus, a pre-determined dose may serve as a starting point to which further adjustments, as necessary, are made.

In some cases, the pre-determined dose of carbon dioxide is based on a test that includes (i) contacting a first sample of the concrete mix or components of the concrete mix with a first test dose of carbon dioxide to produce a first test carbonated concrete mix or components of the concrete mix; (ii) determining a stiffness and/or rate of stiffening of the first test carbonated concrete mix or components of the concrete mix; and (iii) determining the pre-determined dose of carbon dioxide based at least in part on the first test dose and the stiffness and/or rate of stiffening of the first test carbonated concrete mix or components of the concrete mix. Generally the actual mix design will be used, but it is also possible that a partial mix containing only certain components of the mix design will be used, such as the cement, one or more admixtures, and the like, may be used. The stiffness may be determined by any suitable means known in the art, such as the well-known slump test (in which case stiffness is expressed as the slump distance, with a low slump indicating high stiffness and a high slump indicating low stiffness), or with an instrument such as a rheomixer, as described in the Examples (in which case the yield stress value is taken as in indicator of stiffness, with a high yield stress indicating high stiffness and a low yield stress indicating low stiffness). Rate of stiffening is determined by taking stiffness measurements at various time points and determining the change in stiffness over time.

Additional or alternative measurements may also be used in pre-testing to determine or refine the dose of carbon dioxide and/or other additives used in the actual job. For example, if the desired effect of carbonation includes reduction of form pressure, doses of carbon dioxide may be tested for their effect on pressure of columns of concrete at one or more heights, generally one or more heights corresponding to the expected height or heights in a form where a particular pressure is desired, or below which pressure is desired; this can be used in addition to, or in place of, stiffness measurements. Methods of determining pressure, e.g., hydrostatic form pressure, are known in the art, for example, pressure sensors integrated into form walls or in simple columns (laboratory testing).

In certain embodiments, step (i) further includes contacting a second sample of the concrete mix or components of the concrete mix with a second test dose of carbon dioxide to produce a second test carbonated concrete mix or components of the concrete mix, where the second test dose is different from the first test dose; step (ii) further comprises determining a stiffness and/or rate of stiffening of the second test carbonated concrete mix or components of the concrete mix; and step (iii) comprises determining the pre-determined dose of carbon dioxide based at least in part on the first test dose and the stiffness and/or rate of stiffening of the first test carbonated concrete mix or components of the concrete mix and the second test dose and the stiffness and/or rate of stiffening of the second test carbonated concrete mix or components of the concrete mix. It will be appreciated that any suitable number of samples and test doses may be tested in this way, e.g. a third sample and third test dose, fourth sample and fourth test dose, fifth sample and fifth test dose, sixth sample and sixth test dose, seventh sample and seventh test dose, eighth sample and eighth test dose, etc. The samples may be different samples, or they may be a single sample that is subjected to successive doses of carbon dioxide to produce the second, third, fourth, etc. dose of carbon dioxide, where the sample is subjected to suitable tests at each dose (e.g., a portion of the sample removed for testing).

The mixer and carbon dioxide contact system used in the test procedure may be any suitable mixer and system. See Examples for exemplary systems. The efficiency of carbonation of the test system, that is, the percentage of carbon dioxide contacted with the concrete mix samples that is actually incorporated in the carbonated concrete mix, may be known for a given system, or may be measured by measuring actual carbonation values for one or more of the samples used in the test, or some combination thereof. Methods of measuring carbonation of concrete mixes are known in the art. The efficiency of carbonation of the particular mixer that is used to mix the concrete mix to be used in the operation may be the same as, or similar to, the test mixer, or it may be different. In the latter case, the relative efficiencies of the test mixer as opposed to the mixer to be used to produce carbonated concrete for the operation may be taken into account when determining the pre-determined dose of carbon dioxide used. For example, if the test mixer has a carbonation efficiency of 90% for a given dose of carbon dioxide and the mixer and carbonation setup to be used to produce the carbonated concrete mix for use in the operation has only a 60% efficiency, then the dose found with the test mixer to produce the desired stiffness and/or rate of stiffening may be multiplied by a factor of 1.5 to give the pre-determined dose. This, of course, is merely exemplary and the exact factor would depend on the actual relative efficiencies of the two systems.

Method of the invention may also include determining the stiffness and/or rate of stiffening of an uncarbonated concrete mix of the mix design, or components thereof, that is, an uncarbonated sample that is the same as the carbonated samples except for the addition of carbon dioxide, and comparing the stiffness and/or rate of stiffening of the carbonated samples to the uncarbonated sample. A pre-determined dose of carbon dioxide may be chosen to produce a desired increase in stiffness and/or rate of stiffening of the carbonated concrete mix compared to the uncarbonated concrete mix, such as an increase of at least 5, 10, 20, 30, 50, 70, 100, 150, 200, 250, or 300% in stiffness and/or rate of stiffening in carbonated compared to uncarbonated concrete mix for the pre-determined dose of carbon dioxide, or an increase of 5-500%, 10-500%, 50-500%, 100%-500%, or 200-500%, or 5-400%, 10-400%, 50-400%, 100%-400%, or 200-400%, or 5-300%, 10-300%, 50-300%, 100%-300%, or 200-300%, or 5-200%, 10-200%, 50-200%, or 100%-200% in stiffness and/or rate of stiffening in carbonated compared to uncarbonated concrete mix for the pre-determined dose of carbon dioxide. In other cases, the pre-determined dose may be one that gives an absolute value for stiffness or within a range of an absolute value for stiffness, generally a value that is known to be optimum or desired for the given operation. Stiffness may be measured by, e.g., the traditional slump test, or by measurement of yield stress, e.g., using a rheomixer as described herein. Thus, in certain embodiments, the pre-determined dose of carbon dioxide may be one that produces a decrease in slump (vertical), compared to uncarbonated concrete, of 5-100%, 5-95%, 5-90%, 5-80%, 5-70%, 5-60%, 5-50%, 5-40%, 5-30%, 5-20%, 5-10%, 10-100%, 10-95%, 10-90%, 10-80%, 10-70%, 10-60%, 10-50%, 10-40%, 10-30%, 10-20%, 20-100%, 20-95%, 20-90%, 20-80%, 20-70%, 20-60%, 20-50%, 20-40%, 20-30%, 30-100%, 30-95%, 30-90%, 30-80%, 30-70%, 30-60%, 30-50%, 30-40%, 40-100%, 40-95%, 40-90%, 40-80%, 40-70%, 40-60%, 40-50%, 50-100%, 50-95%, 50-90%, 50-80%, 50-70%, or 50-60%. In certain embodiments, the pre-determined dose of carbon dioxide may be one that produces a decrease in slump (vertical), compared to uncarbonated concrete, of at least 0.5, 1, 1.5, 2, 2.5, 3, 3.5, 4, 4.5, 5, 5.5, 6, 6.5, 7, 7.5, 8, 8.5, 9, 9.5, or 10 inches, or a decrease in slump compared to uncarbonated concrete of 0.5-10, 0.5-8, 0.5-6, 0.5-4, 0.5-2, 0.5-1, 1-10, 1-8, 1-6, 1-4, 1-2, 2-10, 2-8, 2-6, 2-4, 3-10, 3-8, 3-6, 3-4, 4-10, 4-8, 4-6, 5-10, 5-8, 5-6, or 6-10 inches. In certain embodiments, the pre-determined dose of carbon dioxide is one that produces no slump. The test for slump may be a standard test, such as, in the United States, the test outlined for ASTM C 143. If a rheomixer is used, the predetermined dose of carbon dioxide may be a dose that produces an increase of at least 5, 10, 20, 30, 50, 70, 100, 150, 200, 250, or 300% in yield stress and/or rate of increase in yield stress in carbonated compared to uncarbonated concrete mix for the pre-determined dose of carbon dioxide, or an increase of 5-500%, 10-500%, 50-500%, 100%-500%, or 200-500%, or 5-400%, 10-400%, 50-400%, 100%-400%, or 200-400%, or 5-300%, 10-300%, 50-300%, 100%-300%, or 200-300%, or 5-200%, 10-200%, 50-200%, or 100%-200% in yield stress or rate of increase in yield stress. Generally it will be desired that the viscosity of the concrete be such that it is sufficiently flowable for the purposes for which it will be used. Thus in certain embodiments the pre-determined dose of carbon dioxide is one that produces the desired effect on stiffness and/or rate of stiffening, as measured by slump or yield stress or other suitable means, while maintaining sufficient viscosity for the intended use.

The determination of the pre-determined dose of carbon dioxide can be dependent on the expected temperature at the site where the carbonation will occur and/or transportation and use will occur. Thus, in embodiments in which testing is used, the contacting of the test sample or samples with carbon dioxide can be conducted at a temperature that at or close to the temperature at which the contacting will be occurring when the pre-determined dose is used in mixing, for example, at the expected temperature or within 1, 2, 3, 4, 5, 6, 7, 8, or 9° C. of the expected temperature at which the wet concrete mix will be contacted with the pre-determined dose of carbon dioxide. Alternatively, the contacting of the test sample or samples with carbon dioxide can be done at a plurality of different temperatures and the pre-determined dose for any given mix operation based on the test results for the temperature nearest to the actual temperature on the day of the mixing. Similar effects of temperature can also be determined for determination of rate of stiffening, if it is expected that the concrete mix will be at a different temperature after mixing at different times, for example, during transport or use in the operation.

With some concrete mixes carbonation produces little or no change in the viscosity of the mix, or a change in viscosity that is within acceptable limits. The methods of the invention can include measurement of the viscosity of the carbonated concrete mixes, and a determination that the viscosity is within acceptable limits. Viscosity can be measured by any suitable means, for example, using a rheomixer as described in the Examples, or by T500 time during a slump test or time to flow through a V Funnel. The ASTM C-1611 test of slump flow may be used, as well, or non-U.S. equivalent. If the viscosity of the carbonated mix is suitable for use in the intended operation then the carbonated concrete mix may be used as is. If the viscosity of the carbonated mix that is at the desired level of stiffness and/or rate of stiffening falls outside of the suitable range for the intended use, further tests may be conducted; alternatively, such tests may be conducted in parallel with carbonation tests. Generally, such tests involve adjusting the mix design to modulate the viscosity, usually to decrease the viscosity, so that it is within acceptable limits for the intended operation. Such adjustments may include addition of water and/or addition of one or more admixtures at a suitable dosage. Since the use of an admixture may itself affect stiffness (see Examples 6-8) the pre-determined dose of carbon dioxide may have to be adjusted, generally according to the results of tests of combinations of admixture dosages and carbon dioxide dosages, so that the desired combination of increase in stiffness and/or rate of stiffening and acceptable viscosity is achieved. Any suitable admixture may be used, and viscosity-modulating admixtures are well-known in the art, and include polycarboxylate-based admixtures and superplasticizers. Viscosity-modifying admixtures include high molecular weight polymers or inorganic materials such as colloidal silica. Carbohydrates or carbohydrate-derivatives may be used. Non-limiting examples of suitable admixtures include carbohydrates or carbohydrate derivatives, e.g., sugars such as fructose, glucose, or sucrose; sugar derivatives such as sodium gluconate and sodium glucoheptonate; organic polymers, such as polycarboxylic ethers, sulfonated napthalene formaldehyde, sulfonated melamine formaldehyde, and lignosulfonates. See PCT Application No. PCT/CA2014/050611 for further examples and discussions of admixtures for use in carbonated concrete mixes. The admixture or admixtures may be added before, during, or after carbonation of the cement mix, e.g., hydraulic cement mix, or any combination thereof. For example, in certain embodiments, the admixture is added after carbonation; in other embodiments, the admixture is added before carbonation; in yet other embodiments, the admixture is added in two, three, or more split doses, e.g., one before carbonation and one during and/or after carbonation.

Thus, in certain embodiments the method may also include delivering a pre-determined dose of an admixture to the concrete mix, wherein the type and/or amount of admixture used is known and/or predicted to produce a desired viscosity or range of viscosities under the conditions of the carbonation, mixing and/or operation. In some cases, the pre-determined dose may be based on the mix design of the wet concrete mix, for example, based on the type of cement used in the mix design, and/or the carbon dioxide dose to carbonate the mix design, and the like. In such cases, generally the known effects of admixture on a mix design containing the component or components are used to determine the dose of admixture to be used in the actual mix and/or operation.

In some cases, the pre-determined dose of admixture is based on a test that includes carbonation of test samples as described above and, in addition, at one or more levels of carbonation, also (i) contacting a first sample of the carbonated concrete mix or carbonated components of the concrete mix with a first test dose of admixture to produce a first test carbonated admixture concrete mix or components of the concrete mix; (ii) determining a viscosity of the first test carbonated admixture concrete mix or components of the concrete mix; and (iii) determining the pre-determined dose of admixture based at least in part on the first test admixture dose and the viscosity of the first test carbonated admixture concrete mix or components of the concrete mix. Generally the actual mix design will be used, but it is also possible that a partial mix containing only certain components of the mix design will be used, such as the cement, one or more admixtures, and the like, may be used. The viscosity may be determined by any suitable means known in the art, such as an instrument such as a rheomixer, as described in the Examples, or by T500 time during a slump test or time to flow through a V Funnel. The ASTM C-1611 test of slump flow may be used, as well, or non-U.S. equivalent.

In certain embodiments, step (i) further includes, at one or more levels of carbonation, contacting a second sample of the carbonated concrete mix or carbonated components of the concrete mix with a second test dose of admixture to produce a second test carbonated admixture concrete mix or components of the concrete mix, where the second test dose is different from the first test dose; step (ii) further comprises determining a viscosity of the second test carbonated admixture concrete mix or components of the concrete mix; and step (iii) comprises determining the pre-determined dose of admixture based at least in part on the first test dose and the viscosity of the first test carbonated admixture concrete mix or components of the concrete mix and the second test dose and the viscosity of the second test carbonated admixture concrete mix or components of the concrete mix. It will be appreciated that any suitable number of samples and test doses may be tested in this way, e.g. a third sample and third test dose, fourth sample and fourth test dose, fifth sample and fifth test dose, sixth sample and sixth test dose, seventh sample and seventh test dose, eighth sample and eighth test dose, etc. The samples may be different samples, or they may be a single sample that is subjected to successive doses of admixture to produce the second, third, fourth, etc. dose of admixture, where the sample is subjected to suitable tests at each dose (e.g., a portion of the sample removed for testing).

When viscosity tests are used, a certain level or range of viscosities may be set to determine if the carbonated concrete mix “passes,” and the level or range of viscosities typically will be highly dependent on the intended use of the concrete. For example, concrete that is used in operations where vibration is applied to poured concrete, such as most precast and slip form operations, and some operations in which concrete is placed in forms, may be sufficiently flowable with the vibration to achieve the desired conformation to the form, density, and the like, and a low viscosity compared to uncarbonated may be acceptable. In certain embodiments, the pre-determined dose of carbon dioxide and/or admixture is determined under conditions of flow similar to those under which the concrete will be used, e.g., with vibration or other methods of introducing energy into the concrete mix so as to make it more flowable. In addition, in operations where a constant or near-constant mixing may be maintained up to the pour, greater decrease in viscosity may be tolerated.

In certain embodiments, the pre-determined dose of carbon dioxide is determined, at least in part, by the time after commencement of mixing at which the carbon dioxide is expected to be added. For example, where testing is used, during the testing of the carbon dioxide doses, the carbon dioxide can added at a time after mixing of the concrete mix or components of the concrete mix commences that is at or near the time at which carbon dioxide is expected to be added under conditions where the concrete mix is mixed. By “commencement of mixing” is meant the time at which cement contacts mix water so that hydration reactions begin. Thus, if the concrete mix is expected to be used in a precast operation, the carbon dioxide may be added at or even before the commencement of mixing, since a concrete mix is generally used immediately after mixing in a precast operation and there is very little lag time between mixing and use. If the concrete is to be used in a ready-mix operation, the carbon dioxide may be added in the ready-mix operation during batching, at a time shortly after batching (e.g., at a wash rack if the batching facility uses them), or at the job site, which may be minutes or even hours after batching, or even a combination of two or more of the foregoing times. The time after commencement of mixing in the test condition may be chosen to match or approximate the time in the ready-mix operation at which the carbon dioxide will be added.

Carbonated concrete samples may also be tested for compressive strength at one or more time points, for example, at one or more of 12, 24, 48 hrs, 7 days, 14 days, 28 days, or 56 days, or any other suitable or desired time as indicated by the intended use of the carbonated mixture. Additional test, e.g., admixture tests may also be performed to determine a type and/or amount of admixture to modulate compressive strength at one or more time points, for example, to increase compressive strength at one or more time points, and the method may include addition of admixture in a type and at an amount determined at least in part on the basis of such pre-testing. Suitable admixtures for modulation of the time course of strength development are know in the art.

It will be appreciated that other conditions and/or characteristics of the concrete mix may be taken into account in determining the pre-determined dose of carbon dioxide and/or other components, for example, in pre-testing, in addition to the above, to determine dosage of carbon dioxide and, if desired or necessary, admixtures or other components to be used under the job conditions.

The invention also provides systems. In certain embodiments the invention provides a system comprising (i) a concrete mixing facility in which a concrete mix is carbonated by contacting the mix with a pre-determined dose of carbon dioxide to produce a carbonated concrete mix that has a greater stiffness or rate of stiffening compared to the same concrete mix if it is not carbonated, where the concrete mix is for use in an operation; (ii) a testing facility in which the pre-determined dose of carbon dioxide is determined; and (iii) a communication system to communicate the pre-determined dose of carbon dioxide determined in the test facility to the concrete mixing facility. The operation in which the carbonated concrete is used can be any suitable operation, such as a precast operation, a slip form operation, an operation in which concrete is poured into fixed forms, or a 3D concrete printing operation. The concrete mixing facility and the testing facility can be separate facilities. The concrete mixing facility can include a concrete mixer and one or more sources of one or more concrete materials, such as cement, aggregate, water, and/or admixtures. The testing facility can include a test concrete mixing apparatus, a carbon dioxide delivery and metering apparatus, and a concrete stiffness test apparatus. The testing facility may further include apparatus for testing viscosity.

The operation in which the carbonated concrete mixes of the methods and compositions of the invention is to be used may be any suitable operation, as known in the art or described herein, where an increase in stiffness and/or rate of stiffening is desired. In certain embodiments, the operation is a precast operation, that is, an operation in which objects are cast in concrete in a mold and the mold removed to produce the final object. It is advantageous to have the cast object in the mold for as short a time as possible, so that the mold may be used again as quickly as possible. The methods of the invention include decreasing the length of time from casting to removal of the mold so that the object is of sufficient structural integrity to be free-standing, e.g., the time from casting to removal of the mold may be decreased by at least 10, 20, 30, 40, 50, 60, 70, 80, or 90% for the concrete mix carbonated with a pre-determined dose of carbon dioxide compared to the time for an uncarbonated mix of the same design, while the integrity and strength of the object remains within allowable limits. The cast object may be any pre-cast object, as known in the art, such as a brick, block, tile, construction panel, conduit, basin, beam, column, concrete slab, or acoustic barrier. Thus in certain embodiments, the methods of the invention include decreasing the length of time from casting to removal of the mold so that the object is of sufficient structural integrity to be free-standing, e.g., the time from casting to removal of the mold may be decreased by at least 10, 20, 30, 40, 50, 60, 70, 80, or 90% for the concrete mix carbonated with a pre-determined dose of carbon dioxide compared to the time for an uncarbonated mix of the same design, while the integrity and strength of the object remains within allowable limits, where the precast object is a slab, panel, wall form, pipe, brick, stone, retaining wall unit, wall panel, roof tile, flooring tile, bench, countertop, step, concrete block, concrete masonry unit; or a concrete and precast concrete agricultural products, such as a bunker silo, cattle guard in the nature of fencing, agricultural fencing; or a precast concrete object used in construction, such as cladding, trim, foundation, beam, floor, wall; or a precast concrete object for use in cemetery vaults and mausoleums, for use in storing hazardous materials, for use for marine products such as floating dock, underwater infrastructure, namely, foundations, beams, and walls, concrete decking and railings, for modular paving for residential, commercial and public use; pre-stressed and structural concrete products, such as concrete beams, spandrels, columns, single and double tees, wall panels, segmental bridge units, bulb-tee girders, I-beam girders; concrete earth retaining walls; concrete and precast concrete for use in building sanitary and storm water retention products, for use in the construction, safety and site protection of road, airport and railroad transportation systems, culverts, bridge systems, railroad crossings, railroad ties, short-span bridges, sound walls and barriers, traffic barriers and tunnel segments, for use in utility structures, namely, for communications, electrical, gas or steam systems, such as hand holes, light pole bases, meter boxes, panel vaults, pull boxes, telecommunications structures, transformer pads, transformer vaults, trenches, utility buildings, utility vaults, utility poles, and controlled environment vaults (CEVs); concrete and precast concrete for use in water and wastewater aeration systems, distribution boxes, dosing tanks, dry wells, grease interceptors, leaching pits, sand-oil/oil-water interceptors, septic tanks, water/sewage storage tanks, wet wells and fire cisterns. These are merely exemplary and it is understood that any object which is capable of being precast is amenable to the methods and compositions of the invention. In general in a precast operation the mixing time is short and the concrete mix is used immediately after mixing.

In certain embodiments the operation is a slip form operation, that is, an operation in which concrete is poured into a continuously moving form. The slip form operation may be a horizontal slip form operation, such as pavement and traffic separation walls, or a vertical slip form operation, such as mining head frames, ventilation structures, below grade shaft lining, and coal train loading silos; theme and communication tower construction; high rise office building cores; shear wall supported apartment buildings; tapered stacks and hydro intake structures, and the like. The methods of the invention may be used to increase the rate of movement of the form by at least 1, 2, 5, 10, 20, 30, 40, 50, 60, 80, 100, 150, or 200% for the concrete mix carbonated with a pre-determined dose of carbon dioxide compared to the rate for an uncarbonated mix of the same design, while the integrity and strength of the construction object remains within allowable limits.

In certain embodiments the operation is an operation in which the concrete mix is poured into fixed forms, such as a construction form. The methods of the invention may be used to decrease the length of time from pouring to removal of the form so that the concrete is of sufficient structural integrity to be free-standing, e.g., the time from pouring to removal of the form may be decreased by at least 10, 20, 30, 40, 50, 60, 70, 80, or 90% for the concrete mix carbonated with a pre-determined dose of carbon dioxide compared to the time for an uncarbonated mix of the same design, while the integrity and strength of the construction object remains within allowable limits. The methods of the invention may be used to decrease the pressure of the concrete on the form at a given height, e.g., the pressure of the wet concrete after pouring at a given height of the form may be decreased by at least 10, 20, 30, 40, 50, 60, 70, 80, or 90% for the concrete mix carbonated with a pre-determined dose of carbon dioxide compared to the pressure for an uncarbonated mix of the same design, while the integrity and strength of the construction object remains within allowable limits.

In certain embodiments the operation is a 3D concrete printing operation, in which a plurality of successive layers is deposited, one on top of each other, to produce a final object. The methods of the invention may be used to decrease the average length of time between successive layers by at least 10, 20, 30, 40, 50, 60, 70, 80, or 90% for the concrete mix carbonated with a pre-determined dose of carbon dioxide compared to the average length of time between successive layers for an uncarbonated mix of the same design, while the integrity and strength of the construction object remains within allowable limits.

### EXAMPLES

### Example 1

Consider a case of a reinforced concrete pipe that is self supporting when freshly filled and compacted. The pipe is vertical with the relatively dry concrete formed around a reinforcing cage. Concrete is delivered to the mold and subjected to vibration to achieve consolidation.

Producers may add cement to make the mix stickier. If the mix becomes too sticky then it may stick to the mold walls and not slide out smoothly when the mold is raised to eject the pipe. In response to the concrete sticking to the mold the producers can alter the mix to add more air or more water. These changes can increase the workability of the mix. After placement excess workability of the mix can cause the concrete to slump over time and thereby lead to stresses and cracks in the concrete and compromise the quality of the pipe.

Instead, the concrete mix is treated with carbon dioxide (prior to delivery to the mold or within the mold) and thereby gains stiffness through the carbonation reaction, and the slump problem is avoided. The stiffening is exhibited soon after placement within the mold/around the cage and the concrete does not slump and cracks are not being created and the pipe quality is maintained.

### Example 2

In this Example, a variety of different cements were tested in a mortar mix to determine variations slump and workability in response to carbonation.

Twenty different cements were tested: Holcim GU (Hol), Lafarge Quebec (LQc), Lehigh (Leh), Lafarge Brookfield (LBr), Federal White (NWh), Illinois Product (Ipr), LaFarge Davenport (LDv), LaFarge MaxCem (LMx), St Mary's (StM), Lafarge Bath (LaB), Calportland Type II (CP2), Calportland Type III (CP3), Calportland Block (CPB), Aalborg Portland Raidcement (ARC), Lehigh White (LeW), Holcim GU-L (HGUL), St Mary's High Early (SMHE), Maxcem Detroit (MxDT), Lafarge Woodstock (LaWD), and Calportland Type I-II (CPBD).

The mortar mix was EN 196 Sand 1350 g, Cement 535 g, Water 267.5 g, w/c Ratio 0.5. CO₂ was added to the mixing bowl at 20 LPM for durations of 0 or 2 minutes. Three of the cements (CP2, Lqc, and LeW) which showed little effect of carbonation for 2 minutes, were further tested with 4 and 6 minutes carbonation; LQc was also tested with 8 min carbonation. Temperature change, slump, flow-spread, CO₂ uptake, and 24 hr cube strength were measured. Workability was calculated as a combination of slump and flow-spread by the following formula: Workability=S+½ (L1+L2a) 100, where S=vertical slump (mm), L1=flow spread in one direction (mm), L2=flow-spread in the direction orthogonal to L1 (mm).

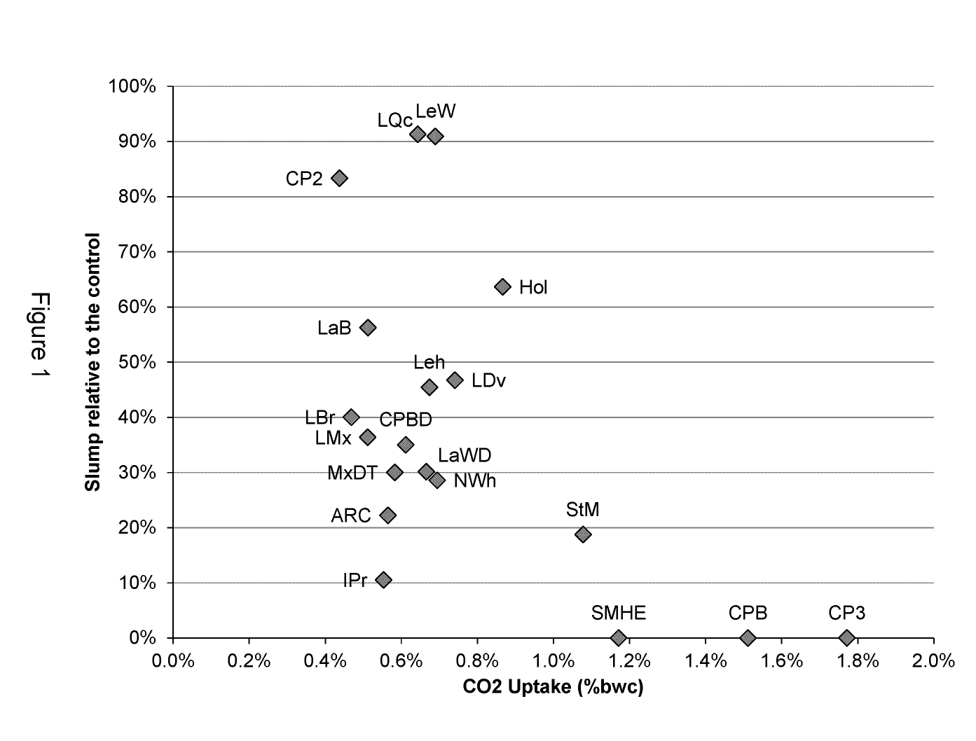

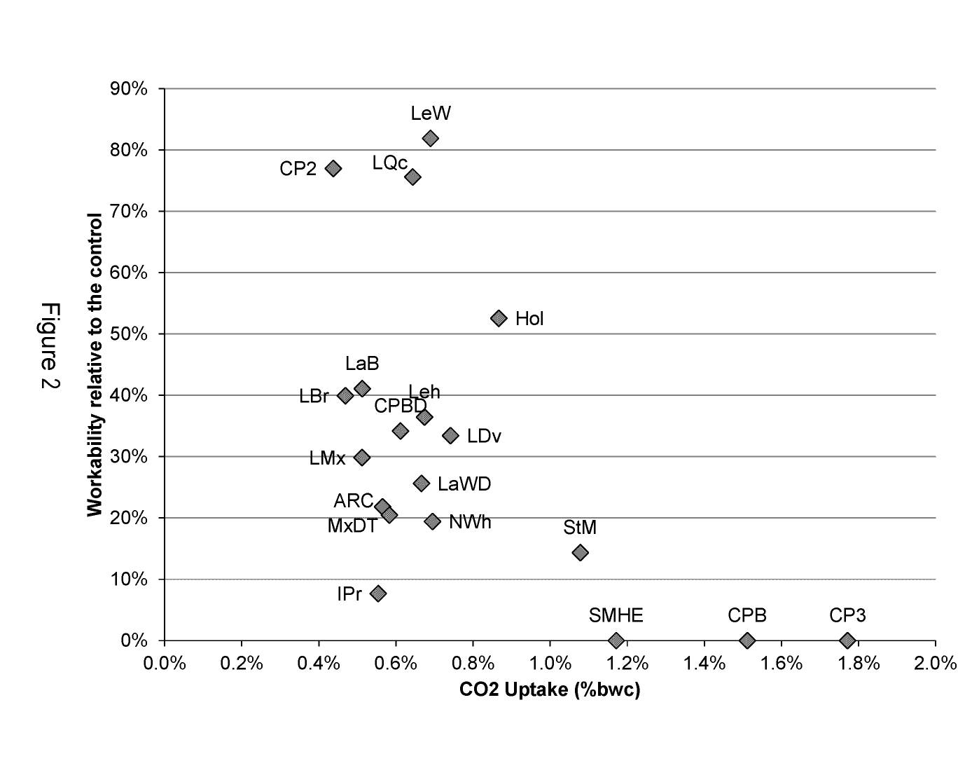

There was considerable variation among the mortars made from the different cements in slump and workability. See FIG. 1 (Slump) and FIG. 2 (Workability). The mortar mixes that had CO₂ uptakes of less than 1.0% showed wide variation in both slump and workability relative to uncarbonated control, with a range of slumps from 10% of uncarbonated control (IPr), i.e., a decrease in slump of 90% compared to uncarbonated control, to almost unchanged from control (LQc and LeW, both of which were at 90% control slump, i.e., a decrease of only 10% from uncarbonated control) (FIG. 1), and similar ranges for workability (FIG. 2). The mortar mixes that had CO₂ uptakes of greater than 1.0% tended to have virtually no slump or workability after carbonation.

In order to further investigate the effects of increasing dose of carbon dioxide in the mortars made with cements that showed the least effect of the 2 min dose (CP2, LQc, LeW), longer periods of carbon dioxide exposure were studied (4, 6, and, in the case of LQc, 8 min of exposure). The results are shown in TABLES 1-3, below. Strengths are 24-hour compressive strengths.

TABLE 1
Additional test data for LQc cement

| | CO2 | Delta | Slump | | Workability | | Strength | |
|---|---|---|---|---|---|---|---|---|
| Time | Uptake | T | Value | % of | Value | % of | Value | % of |
| (min) | (% bwc) | (° C.) | (mm) | control | (mm) | Control | (MPa) | Control |
| 0 | 0 | — | 115 | — | 184.5 | — | 15.0 | 100% |
| 2 | 0.64% | 3.60 | 105 | 91% | 139.5 | 76% | 7.6 | 51% |
| 4 | 0.88% | 6.10 | 70 | 61% | 78.0 | 42% | 8.1 | 54% |
| 6 | 1.74% | 9.20 | 70 | 61% | 88.5 | 48% | 6.4 | 42% |
| 8 | 1.68% | 9.20 | 40 | 35% | 43.5 | 24% | 6.8 | 45% |

TABLE 2
Additional test data for CP2 cement

| | CO2 | Delta | Slump | | Workability | | Strength | |
|---|---|---|---|---|---|---|---|---|
| Time | Uptake | T | Value | % of | Value | % of | Value | % of |
| (min) | (% bwc) | (° C.) | (mm) | control | (mm) | Control | (MPa) | Control |
| 0 | 0 | | 90 | | 130.5 | | 17.7 | 100% |
| 2 | 0.44% | 3.50 | 75 | 83% | 100.5 | 77% | 13.3 | 75% |
| 4 | 1.36% | 6.00 | 40 | 44% | 42.0 | 32% | 11.7 | 66% |
| 6 | 1.50% | 8.30 | 25 | 28% | 26.0 | 20% | 11.4 | 64% |

TABLE 3
Additional test data for LeW cement

| | CO2 | Delta | Slump | | Workability | | Strength | |
|---|---|---|---|---|---|---|---|---|
| Time | Uptake | T | Value | % of | Value | % of | Value | % of |
| (min) | (% bwc) | (° C.) | (mm) | control | (mm) | Control | (MPa) | Control |
| 0 | 0 | — | 55 | | 69 | | 25.0 | 100% |
| 2 | 0.69% | 4.00 | 50 | 91% | 56.5 | 82% | 21.0 | 84% |
| 4 | 0.91% | 6.10 | 25 | 45% | 25.0 | 36% | 17.5 | 70% |
| 6 | 1.81% | 10.20 | 0 | 0% | 0.0 | 0% | 15.4 | 62% |

It can be seen that, in general, increasing time of exposure to CO₂ caused an increase in CO₂ uptake and corresponding decrease in slump and workability compared to control. Thus, a desired alteration in slump/workability can be achieved by titrating the degree of carbonation, and is highly dependent on the type of cement used.

This Example demonstrates that the effect of carbonation of a mix of cement and aggregate (in this case, sand) on slump and workability is highly dependent on the cement type used and the degree of carbonation, and that knowledge of the type of cement and/or the chemistry of the cement is important in determining the effect of carbon dioxide on a mix containing the cement, and in, e.g., determining dose and/or other conditions of carbonation to produce a desired effect on the thixotropic properties of a mx containing the cement.

### Example 3

This Example was designed to show the effect of carbonation on slump at various levels of water addition in a cement mix.

Concrete mixes were prepared as follows: In each batch, approximately 20 kg of bagged ready-mix concrete (BOMIX bagged ready-mix) was mixed with water in a Hobart mixer. The cement content of the concrete was not known but was assumed to be 20%. Total water addition was 2100, 2200, 2300, 2400, or 2500 ml/20 kg dry mix, compared to 2000 ml/kg (w/c=0.5) for control batches; the water was added in two additions. A first water addition of 60% of the total water was added, so the w/c at the time of carbon dioxide was increased as mix water was increased, and the mixer was topped with a loose lid. The concrete mix was mixed for a total of 1 minute. Then a gas mixture containing carbon dioxide at a concentration of 99.5% (Commercial grade carbon dioxide from Air Liquide, 99.5% CO₂, UN1013, CAS:124-38-9) was delivered to contact the surface of the mixing concrete via a tube of approximately ¼″ ID whose opening was located approximately 10 cm from the surface of the mixing concrete, at different flow rates for different batches, for 60 sec, to give a total carbon dioxide dose of 10 gm or 15 gm (1.3 or 1.9% carbon dioxide bwc, respectively). The remaining water was added to bring the mix to the desired total water addition while the concrete mix continued to be mixed after the carbon dioxide addition for approximately 2 minutes, for a total mix time of approximately 4 minutes, with carbon dioxide addition for 60 sec during the mixing (one minute premix, 60 sec CO₂ dose, then add remainder of water and finish with two minutes mixing for 4 minutes total). Control concrete mixes were prepared with the same final total water amounts and mixing time, but no addition of carbon dioxide. The amount of water on the first addition was 60% of the total water so the w/c at time of carbon dioxide was increased as mix water was increased.

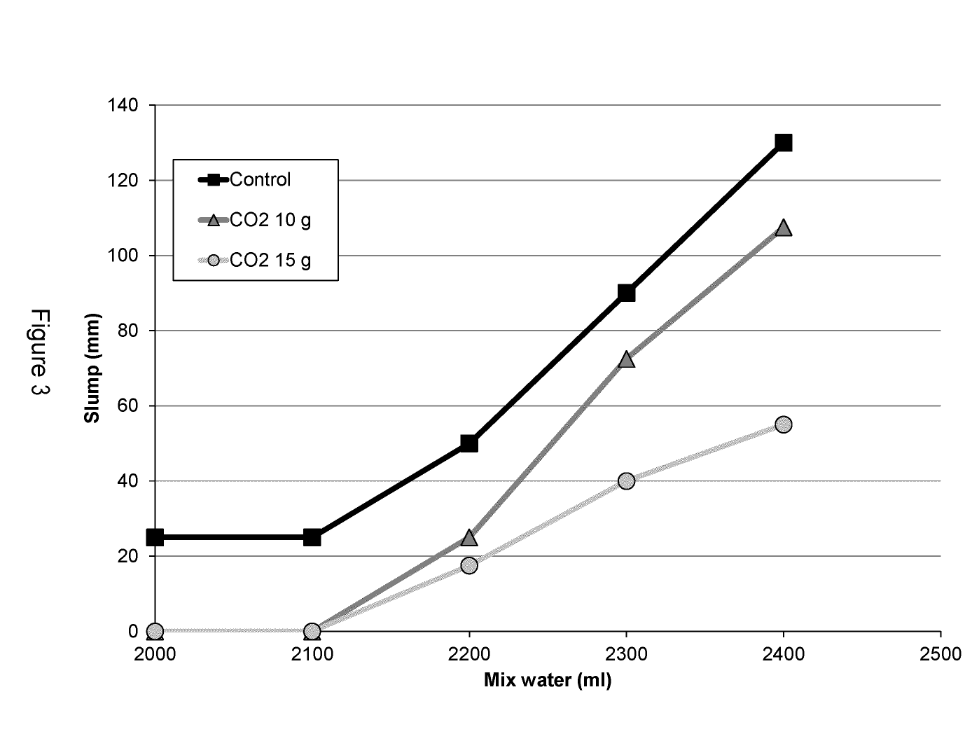

Slump tests were conducted and the results are shown in FIG. 3. At all levels of water, the carbonated concrete mix had lower slump than the uncarbonated, and the 15 gm dose of carbon dioxide had a greater effect on slump than the 10 gm dose of carbon dioxide.

This Example illustrates that carbonation of concrete increases stiffness compared to uncarbonated control, which can be offset by addition of water; at any given water content, however, the carbonated concrete was stiffer than the uncarbonated concrete.

### Example 4

This example describes the use of carbon dioxide to reduce slump of a concrete mix in a ready-mix operations.

The following mix was used:
30 MPa with a maximum 4″ slump
   20 mm aggregate—2780 kg
   Sand—2412 kg
   Washed sand—615 kg
   Type 10 GU cement—906 kg
   Fly ash—192 kg
   Visco 2100-850 ml
   ViscoFlow—1650 ml
   Water—334 litres

The carbon dioxide was added via a ¾″ diameter rubber hose clipped to the side of the truck and disposed in the mixing drum to deliver CO₂ to the surface of the mixing concrete for 180 sec (controlled manually), at low, medium or high dose, to achieve uptakes of 0.43, 0.55, and 0.64% CO₂ bwc, respectively. Because the aggregate was wet, CO₂ was added to the mix before the final addition of water; the w/c of the mix when CO₂ was added was calculated to be 0.16. Final water was added immediately after the CO₂ addition.

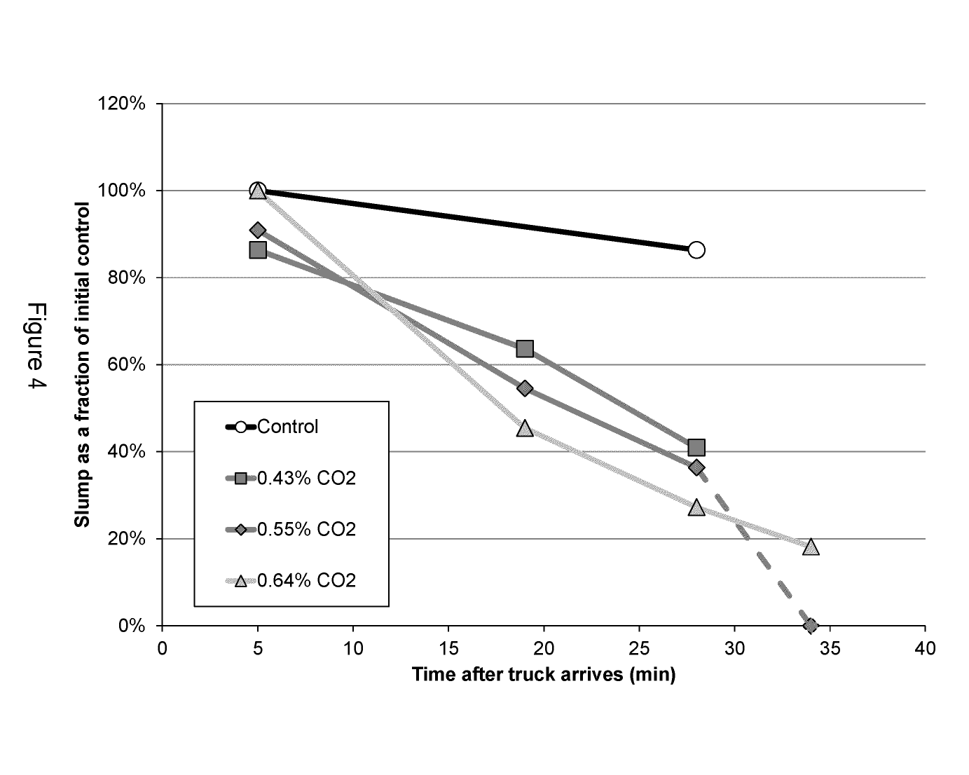

The addition of CO₂ greatly reduced slump as time from arrival at site progressed, see FIG. 4. Carbonated concreted showed reduced strength at 7 days compared to control, increasing in strength over time so that by day 56 the carbonated concrete was stronger than uncarbonated at all doses tested (data not shown).

This example demonstrates that the effect of carbonation on slump of concrete increases with time after addition of the carbon dioxide, compared to the control, uncarbonated concrete. In other words, the carbonated concrete becomes stiffer much faster than the uncarbonated concrete, with no slump at only 35 min after truck arrival for one dose (0.55% CO₂).

### Example 5

This Example illustrates the effect of temperature on effects of carbonation on flowability (slump) of concrete mixes.

Three target starting temperatures were considered, 7° C., 15° C. and 25° C. (actual temperatures were ±2° C.). A mortar mix was prepared containing 535 g Portland cement (Holcim GU), 1350 g sand, and 267.5 g water. The mix was brought to 7, 15, or 25° C., and CO₂ gas was introduced at 20 LPM while mixing. The time of CO₂ delivery depended on the target CO₂ uptake, for example, to achieve 1.1% bwc the delivery took 3 to 4.5 min. CO₂ uptake at various time points was measured. Slump measurements were also taken at various time points.

Rate of uptake of carbon dioxide increased as temperature increased; the rate was 0.087% bwc/min at 7° C., 0.231 bwc/min at 15° C., and 0.331 bwc/min at 25° C. The rate of carbon dioxide uptake increased 278% as temperature increased from 7 to 25° C.

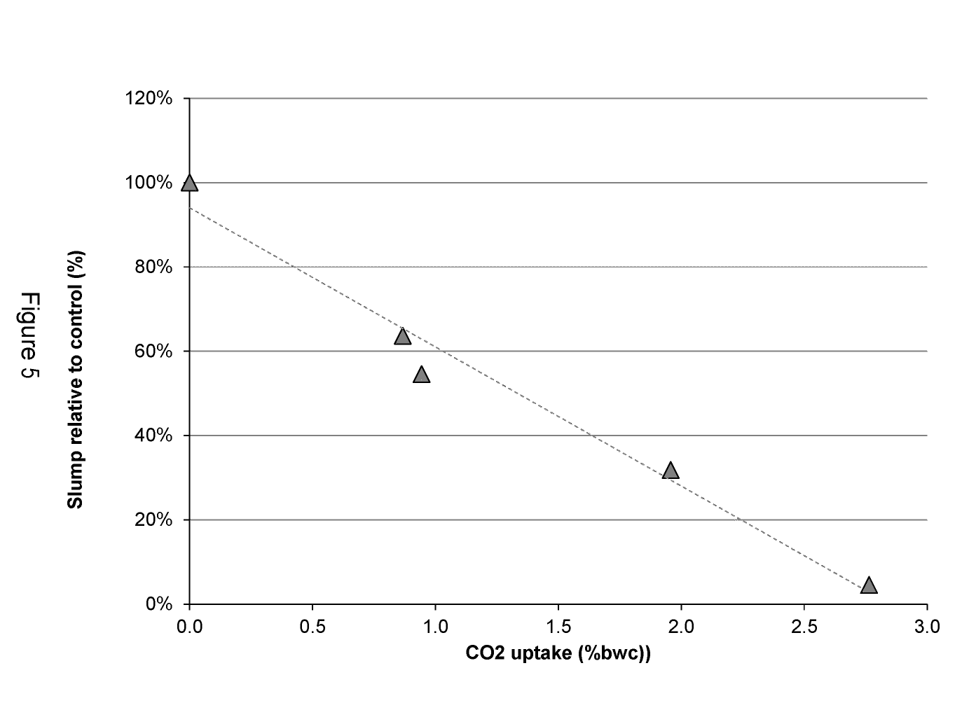

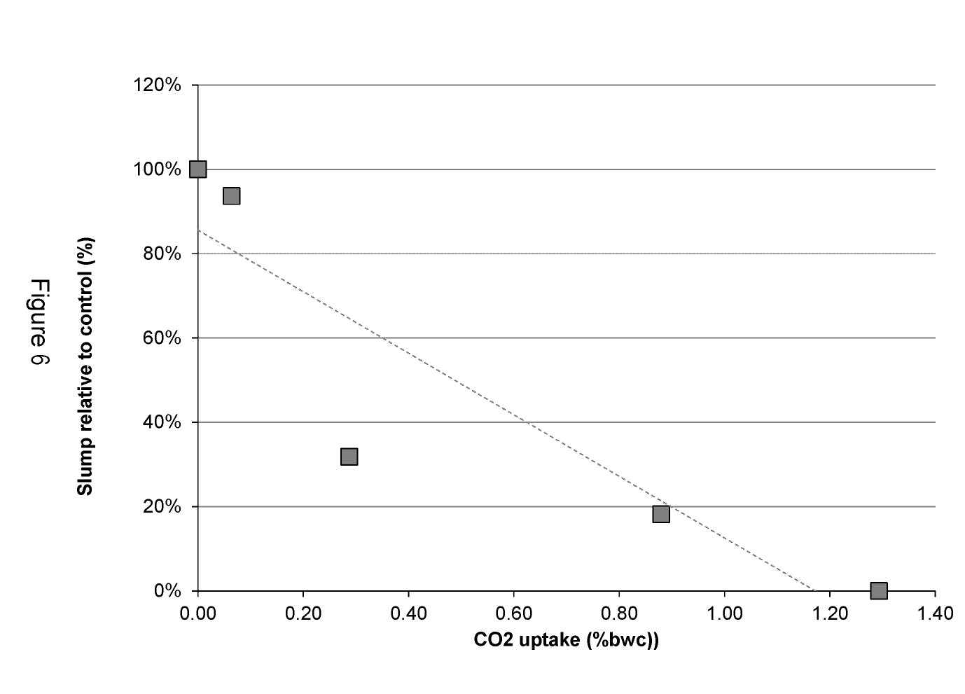

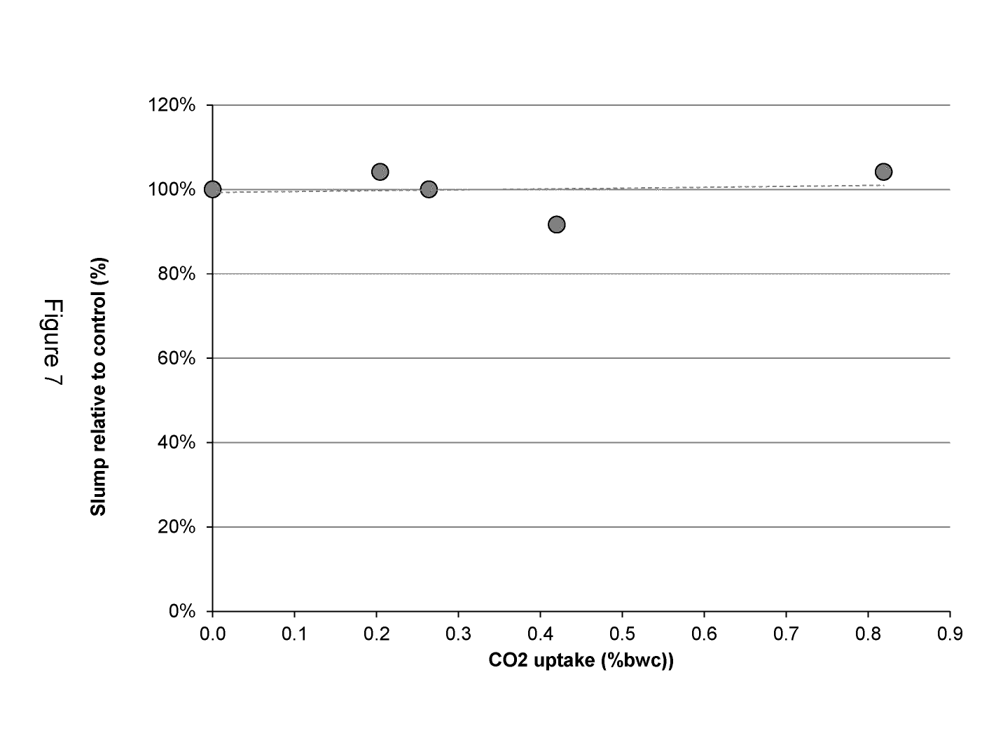

The effect of temperature on slump is shown in FIGS. 5-7. FIG. 5 shows the effect of carbonation at 25° C. on slump; as expected, the greater the degree of carbonation, the greater the effect on slump, with virtually no slump (compared to uncarbonated control) at an uptake of 2.8% bwc. At approximately 1% bwc, the slump was 60% of uncarbonated control. FIG. 6 shows that lower percentages of carbonation were achieved at 15° C., but the effect on slump was much greater, so that the slump at about 0.9% carbonation bwc was only 20% of control. In marked contrast, at 7° C. (FIG. 7), there was virtually no effect on slump at any level of carbonation achieved, up to about 0.83% bwc.

This Example illustrates the marked effect that temperature can have on the effect of carbonation on concrete stiffness, with virtually no effect at 7° C., pronounced effect at 15° C., and intermediate effect at 25° C., even at approximately the same degree of carbonation at all three temperatures.

### Example 6

In this Example, mortars made with two different cements were tested for yield stress and viscosity. The terms “yield stress” and “viscosity” are used in their commonly accepted meanings. Yield stress is the applied stress required to make a structured fluid flow and is a measure of stiffness, and viscosity is a measure of internal friction in a fluid.

A mortar mix containing 1350 g EN 196 Sand, 535 g cement (2 different kinds), 267.5 g water (w/c=0.5), Admix ADVA CAST 575 was used. When carbonating, 20 LPM gas was introduced into mixer for 2 minutes. Briefly, the sand and water were added to the mixer and blended for 30 seconds, then cementitious materials were added, followed by carbonation, if used, then admixture was introduced and blended for 30 seconds. Rheological properties of the mix in this and the following Examples were evaluated using a ConTec Rheomixer, ConTec Steyputaekni ehf., Laugarasevegur 30-104 Reykjavik, Iceland, before and after addition of admixture. Two consecutive admixture doses were added.

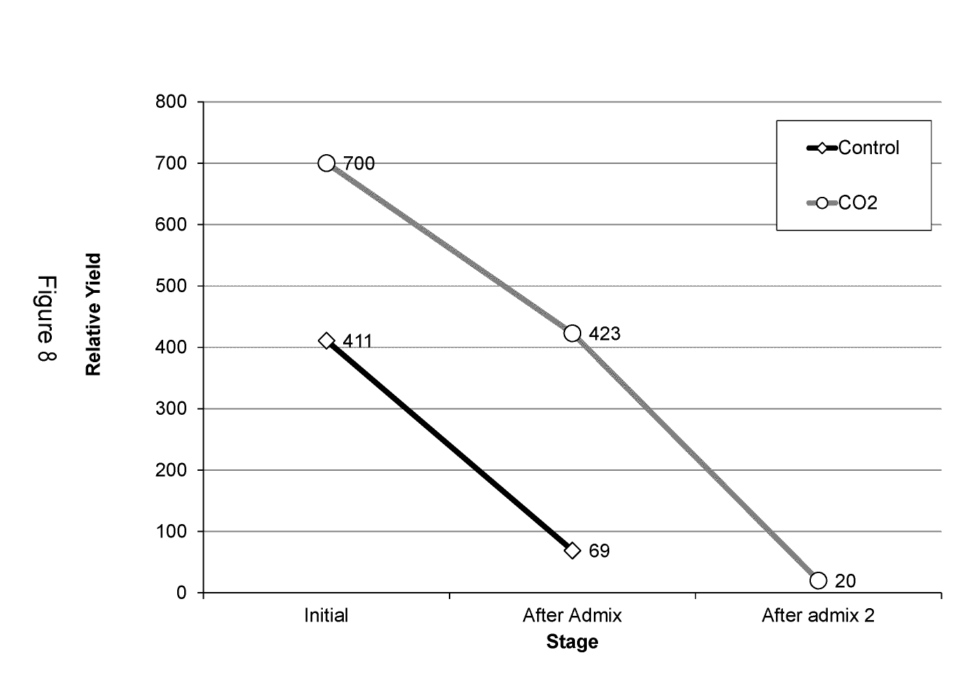

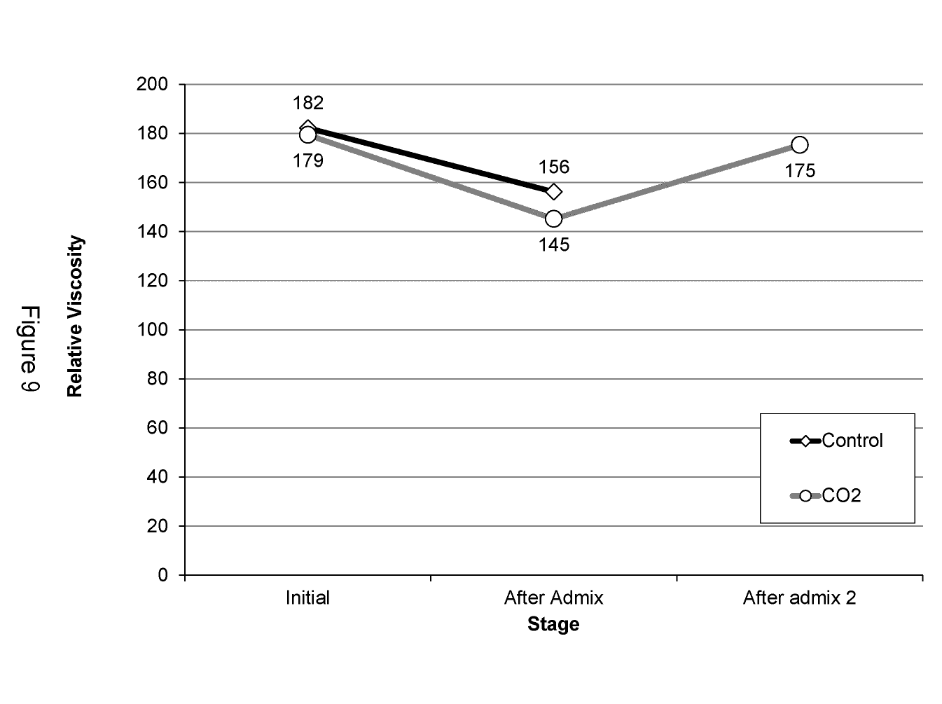

FIGS. 8 and 9 show the effects of carbonation of a mortar mix containing Illinois Product cement on yield stress and viscosity, respectively. Carbonation of the mix had a marked effect on yield stress, which was increased 170% in the carbonated mortar compared to the control, uncarbonated sample, prior to addition of admixture; upon providing the first dose of admixture (1.92 g or 0.36% bwc) the yield stress of the carbonated concrete was 103% of the control without the admixture, and 613% of the control with the first dose of admixture; upon adding a second admixture dose (2.54 g for a total of 0.83% bwc) the yield stress of the carbonated cement was essentially equivalent of that of control after one dose of admixture. See FIG. 8. In marked contrast to yield stress, the viscosity of the samples was very similar under similar admixture conditions whether or not the sample was carbonated (FIG. 9). The 24-hour strength of cubes from the two mixes was almost identical, 35.8 Mpa for uncarbonated control, and 35.5 Mpa for carbonated. The CO2 uptake of the carbonated sample was 1.03% bwc.

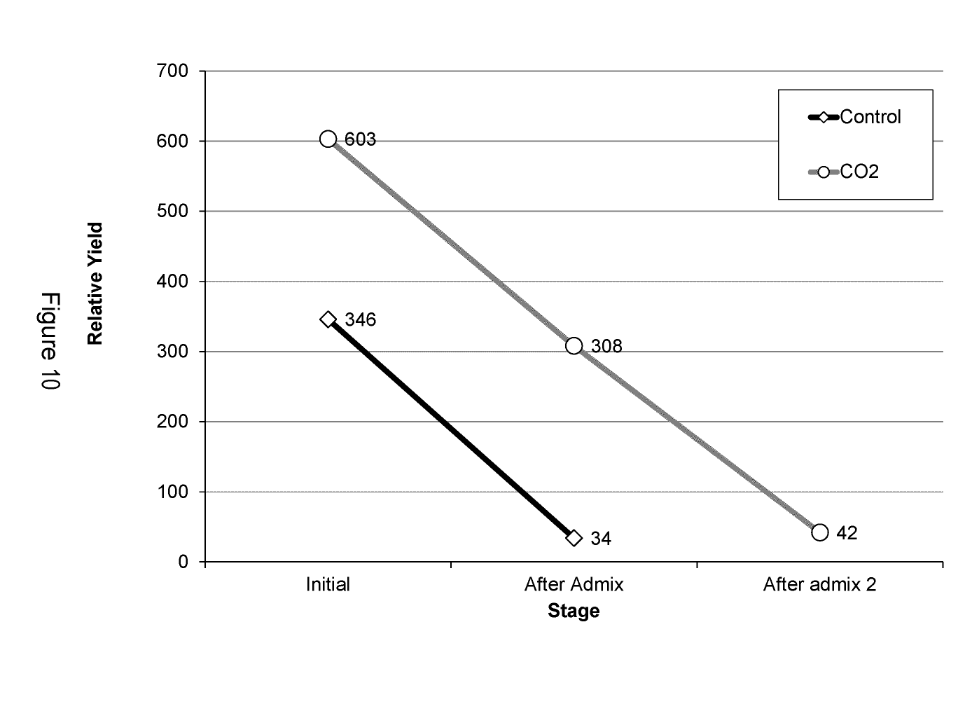

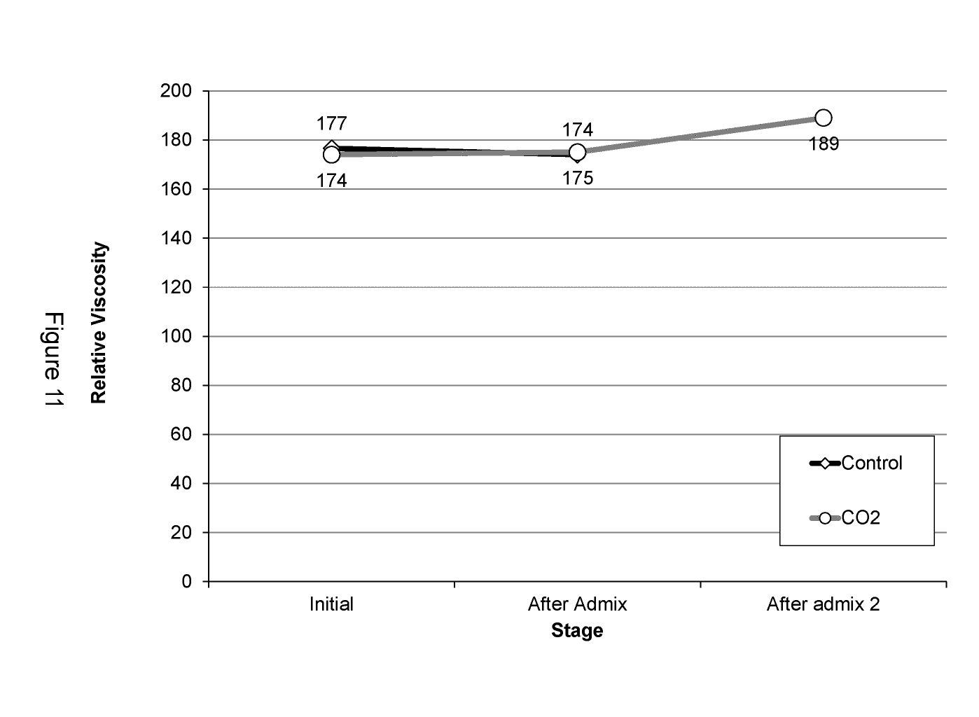

FIGS. 10 and 11 show the effects of carbonation of a mortar mix containing Holcim cement on yield stress and viscosity, respectively. The results were similar to those for the mortar mix using Illinois Product cement: Carbonation of the mix had a marked effect on yield stress, which was increased 174% compared to the control, uncarbonated sample, prior to addition of admixture; upon providing the first admixture dose (1.80 g or 0.34% bwc) the yield stress of the carbonated mortar was 89% of the control mortar without admixture and 906% of the control mortar with admixture; upon addition of the second admixture dose (1.10 g for a total of 0.54% bwc) the yield stress of the carbonated mortar was effectively equivalent of the control, uncarbonated sample, with one dose of admixture. See FIG. 10. In marked contrast to yield stress, the viscosity of the samples was virtually identical under similar admixture conditions whether or not the sample was carbonated (FIG. 11). The 24-hour strength of cubes from the two mixes was different, 25.7 Mpa for uncarbonated control, and 12.7 Mpa for carbonated. The CO₂ uptake of the carbonated sample was 0.29% bwc.

This Example illustrates that carbonation of mortar mixes can have a marked effect on yield stress yet a relatively minor, or no, effect on viscosity. Thus a mix can become relatively stiff when undisturbed but return to a flowable condition when subjected to the proper force (e.g., by agitation). In addition, the type of cement used had an effect on the CO₂ uptake under similar conditions and on early strength, indicating the importance of knowing the type of cement to be used in the mix to determine optimal carbon dioxide dose.

### Example 7

In this Example, mortar samples were prepared and carbonated at different levels of carbonation; admixture was added to adjust each mixture to a constant torque, then rheological properties were followed over time.

The procedure was as follows: The mix was 1350 g EN 196 Sand, 535 g cement (St Mary's Bowmanville), 267.5 g water (w/c=0.5), variable Kao Mighty ES admix. The sand and water were mixed for 30 seconds, cement was added, and the batch was mixed for another 30 seconds. For the control, uncarbonated batch, mixing continued for an additional four minutes. For the carbonated batches, the mixture was exposed to a flow of gaseous CO₂ for 4 minutes at a specified flow rate (1, 2, or 3 LPM). The temperature was measured and then the mortar was introduced into the rheomixer bowl and initial rheology assessed. Seven min after the start of the first rheology test an amount of admixture was added to obtain equivalent torque in all mixes (torque is real time feedback from the machine about the mechanical effort required to move the impeller through the mix). Rheology assessments were then conducted at 8 minute intervals

The conditions, CO₂ uptake, temperature, and amount of admix in each batch are summarized in TABLE 4, below

TABLE 4
Conditions for constant torque test

| | | Flow rate | CO2 Uptake | Temp | Admix | Admix |
|---|---|---|---|---|---|---|
| Batch | Condition | (LPM) | (% bwc) | (° C.) | (g) | (% bwc) |
| 2201 | Control | 0 | 0.00 | 26.4 | 1.60 | 0.30% |
| 2202 | CO2 | 1 | 0.80 | 26.4 | 2.40 | 0.45% |
| 1704 | CO2 | 2 | 1.27 | 32.6 | 2.52 | 0.52% |
| 1705 | CO2 | 3 | 1.03 | 29.4 | 2.77 | 0.47% |

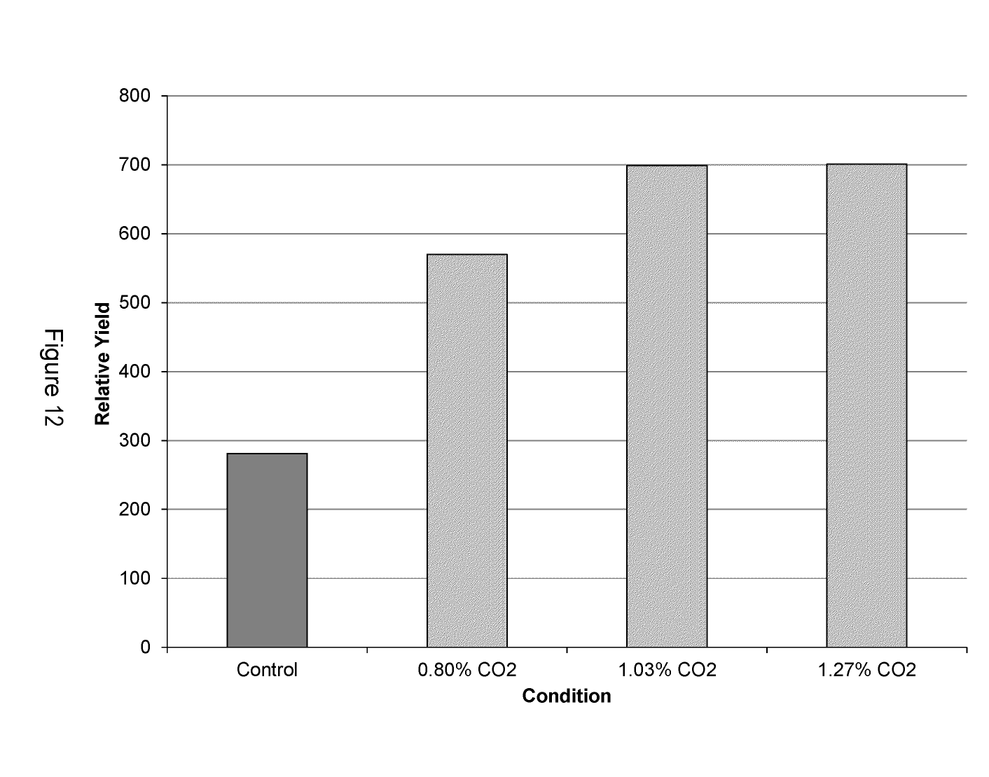

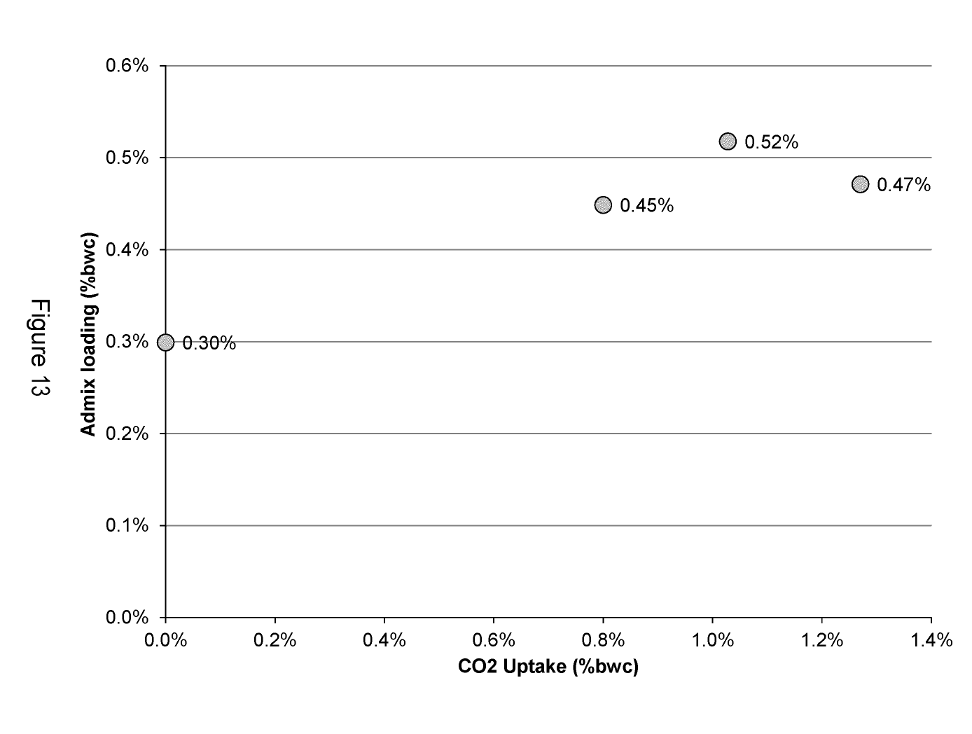

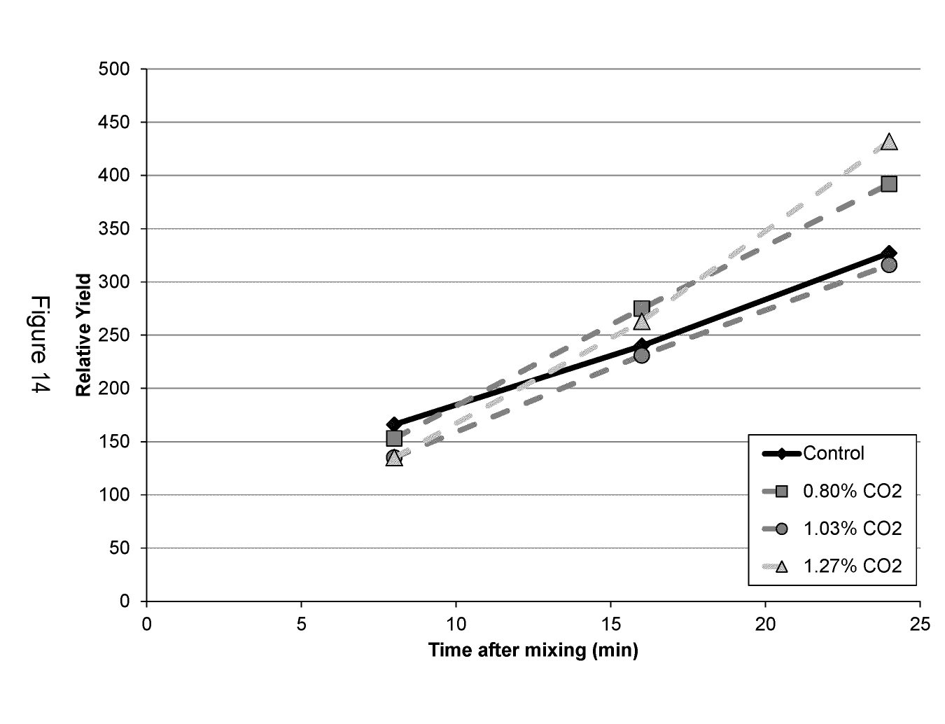

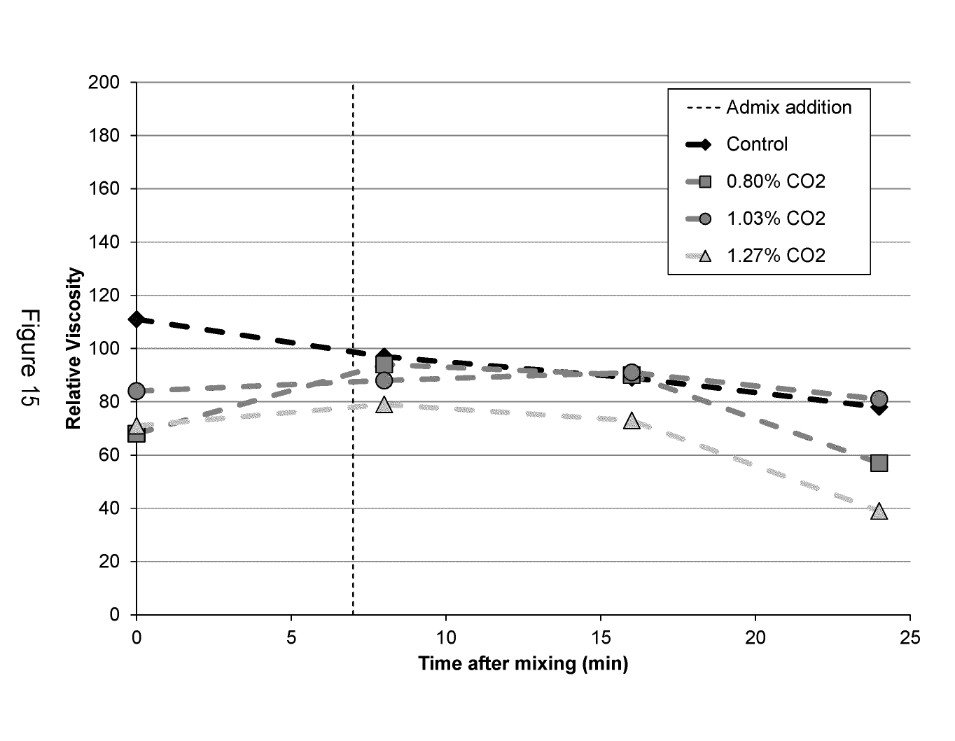

Carbon dioxide uptake was proportional to temperature and not to flow rate. The admixture requirement to achieve the desired torque was higher than for the control but not proportional to CO₂ uptake. The yield stress increased after carbonation (FIG. 12), and the admixture requirement for constant torque also increased after carbonation (FIG. 13). Carbonation increased the rate of increase in yield stress after the admixture was added; i.e., the carbonated mixtures stiffened faster (FIG. 14). Slope was measured as units G per minute, and stiffening after admixture addition was 12 to 84% faster in the carbonated batches (148% of uncarbonated for 0.80% CO₂ bwc, 112% of uncarbonated for 1.03% CO₂ bwc, and 184% of uncarbonated for 1.27% CO₂ bwc). Viscosity of the batches over time is shown in FIG. 15.

This Example illustrates that effects on stiffness can be maintained when an admixture is added to bring viscosity back to a control level, with stiffness increasing 84% faster for the 1.27% bwc CO₂ dose compared to uncarbonated, even when admixture was added to bring both to the same viscosity.

### Example 8

In this Example, mortar samples were carbonated at various levels and a constant amount of admixture was added, and rheological properties were followed over time.

Two tests were performed, using two different cements; the first test used St. Mary's Bowmanville cement, and the second test used Lafarge Brookfield cement. In each case, 1350 g EN 196 sand was mixed with 267.5 g water for 30 seconds, then 535 g cement was added (w/c=0.5) and the mortar was mixed for an additional 30 seconds. For the control, uncarbonated batch, mixing continued for an additional 4 min. For the carbonated batches, the mortar was exposed to gaseous CO₂ at various flow rates for various degrees of carbonation, also over 4 min. The temperature was measured and the mortar was introduced into the rheomixer bowl, where rheology was assessed every 8 minutes. At 7 minutes after the start of the first rheology test, 1.6 g of Kao Mighty ES admixture (0.299% bwc) was injected.

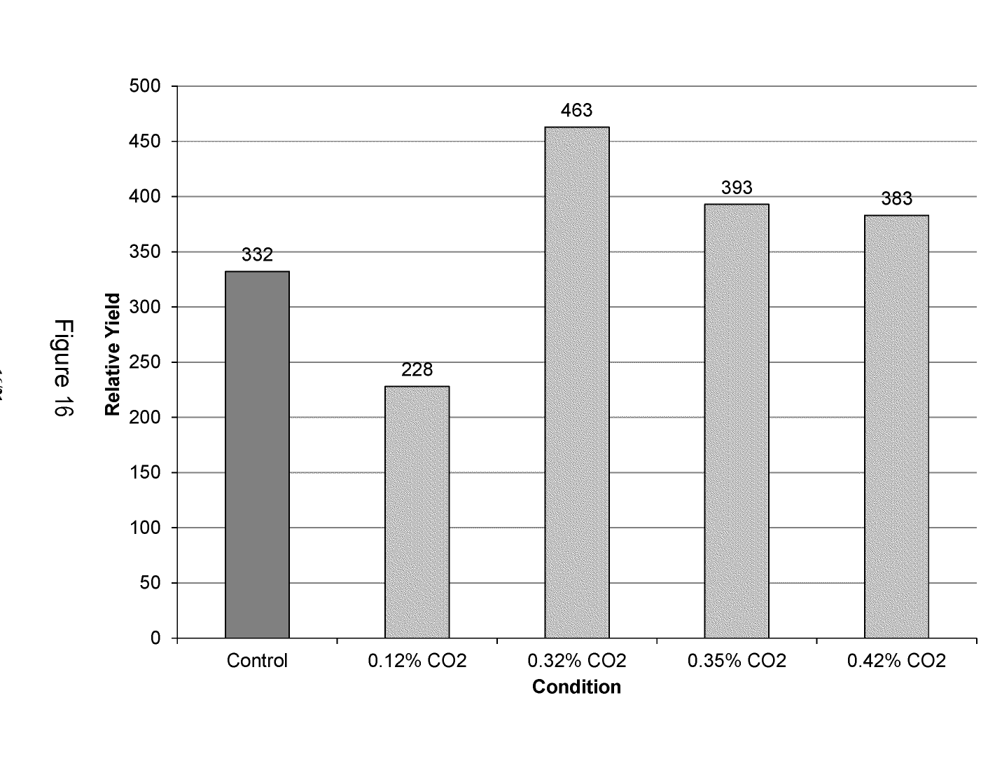

The carbonation conditions, uptake, and temperature for the first test (St. Mary's Bowmanville cement) are shown in TABLE 5, below. Relatively low doses of CO₂ were used, and uptake and temperature increased with increasing flow rate of CO₂. FIG. 16 shows that the lowest uptake seemed to reduce yield stress, while higher uptakes increased yield stress.

TABLE 5
Carbonation conditions, uptake, and temperature, St. Mary's Bowmanville
cement

| | | | CO2 | | |
|---|---|---|---|---|---|
| | | Flow rate | Uptake | Temp | Relative yield |
| Batch | Condition | (LPM) | (% bwc) | (° C.) | @ 0 min |
| 1301 | Control | 0 | 0.00 | 21.9 | 100% |
| 1305 | CO2 | 0.10 | 0.12 | 22.2 | 68% |
| 1304 | CO2 | 0.20 | 0.32 | 23.2 | 139% |
| 1302 | CO2 | 0.25 | 0.35 | 23.8 | 118% |
| 1303 | CO2 | 0.50 | 0.42 | 24.3 | 115% |

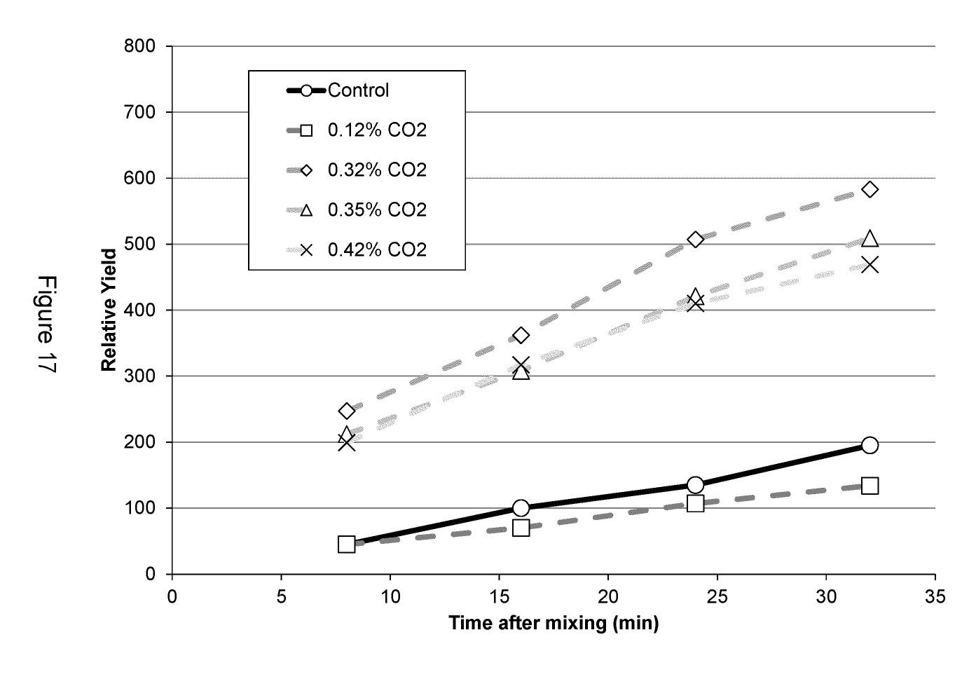

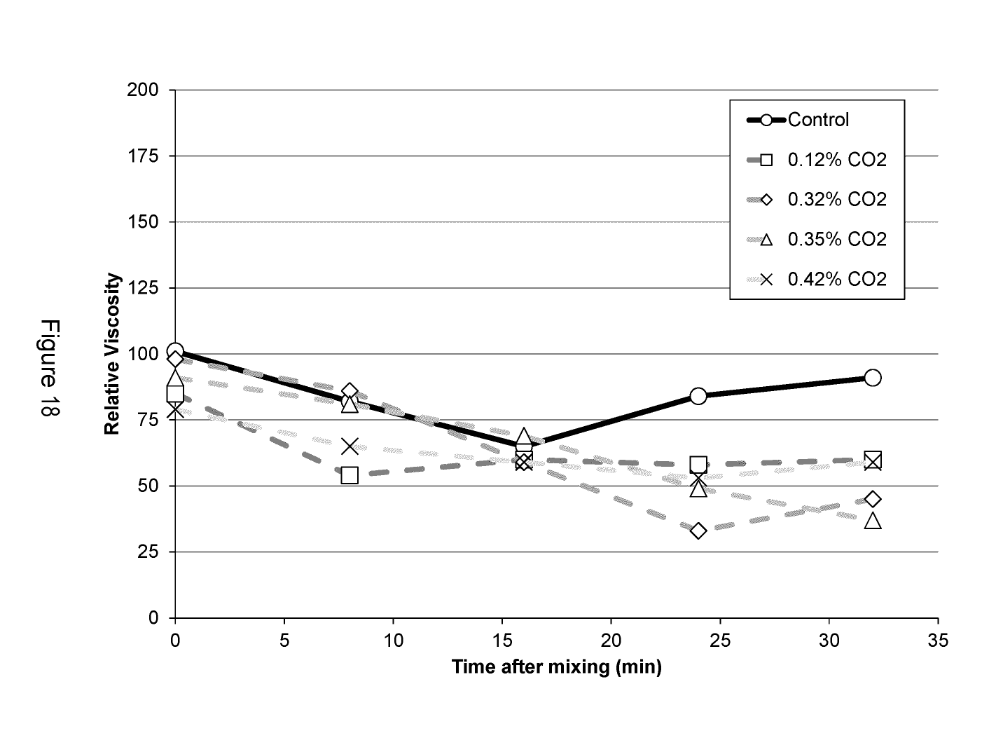

FIG. 17 and TABLE 6 show yield stress relative to uncarbonated control, starting with the addition of the admixture and every 8 minutes thereafter, up to 32 minutes. With addition of admixture, the yield stress for the lowest uptake (0.12% CO₂) became the same as the uncarbonated control, whereas higher doses were 442% to 549% stiffer than uncarbonated control. The stiffening rate (change in yield stress with time) was lower for the low dose, whereas the higher doses stiffened faster (186 to 238% faster than uncarbonated control). FIG. 18 shows that the change in viscosity with CO₂ addition and admixture addition, compared to control, uncarbonated mix, was considerably less than the change in yield stress.

TABLE 6
Rheology after addition of admixture, St. Mary's Bowmanville cement

| | | CO2 | | Slope | |
|---|---|---|---|---|---|
| | | Uptake | Relative Yield | after | Slope relative |
| Batch | Condition | (% bwc) | @ 8 min | admix | to control |
| 1301 | Control | 0.00 | 100% | 6.1 | 100% |
| 1305 | CO2 | 0.12 | 100% | 3.8 | 63% |
| 1304 | CO2 | 0.32 | 549% | 14.4 | 238% |
| 1302 | CO2 | 0.35 | 471% | 12.6 | 207% |
| 1303 | CO2 | 0.42 | 442% | 11.3 | 186% |

The results suggest that, for St. Mary's Bowmanville cement, a low dose of CO₂ had no effect on rheology, whereas higher doses caused stiffening, increased admixture demand, and increased the rate of stiffening.

The carbonation conditions, uptake, and temperature for the second test (Lafarge Brookfield cement) are shown in TABLE 7, below.

TABLE 7
Carbonation conditions, uptake, and temperature, Lafarge Brookfield
cement

| | | | CO2 | | |
|---|---|---|---|---|---|
| | | Flow rate | Uptake | | Relative yield |
| Batch | Condition | (LPM) | (% bwc) | Temp (° C.) | @ 0 min |
| 1907 | Control | — | 0.00 | 21.6 | 100% |
| 1902 | CO₂ | 0.10 | 0.34 | 22.0 | 66% |
| 1903 | CO₂ | 0.20 | 0.53 | 21.5 | 94% |
| 1904 | CO₂ | 0.30 | 0.40 | 22.6 | 99% |
| 1905 | CO₂ | 0.40 | 1.00 | 22.8 | 82% |
| 1906 | CO₂ | 0.50 | 0.80 | 23.9 | 101% |

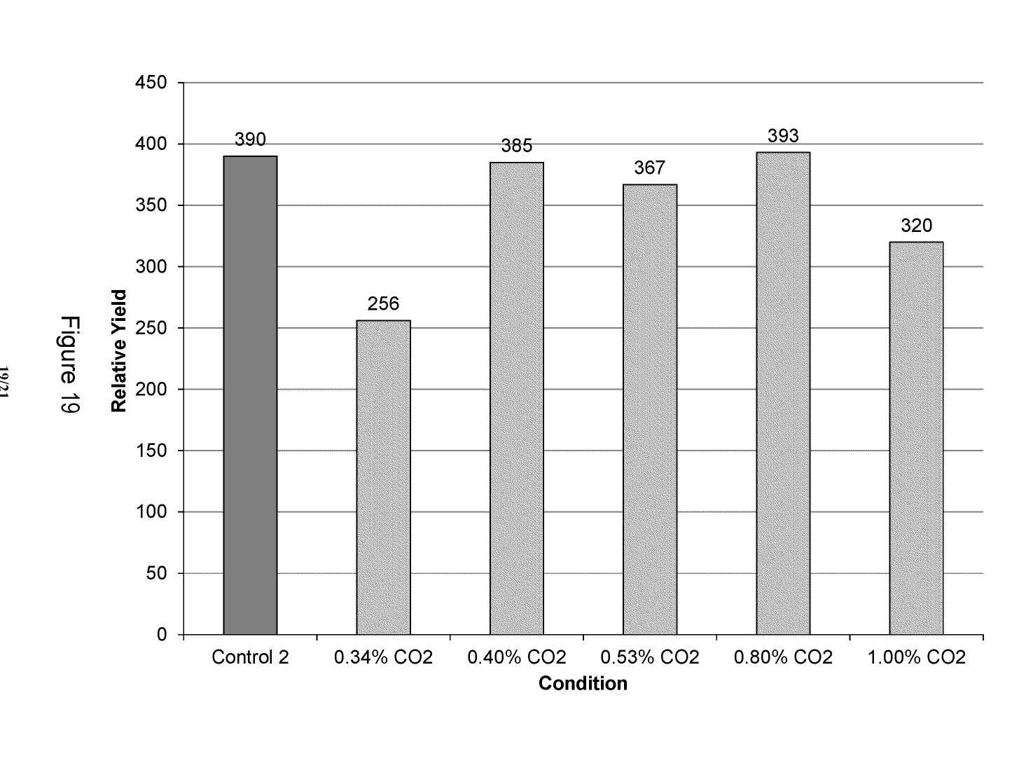

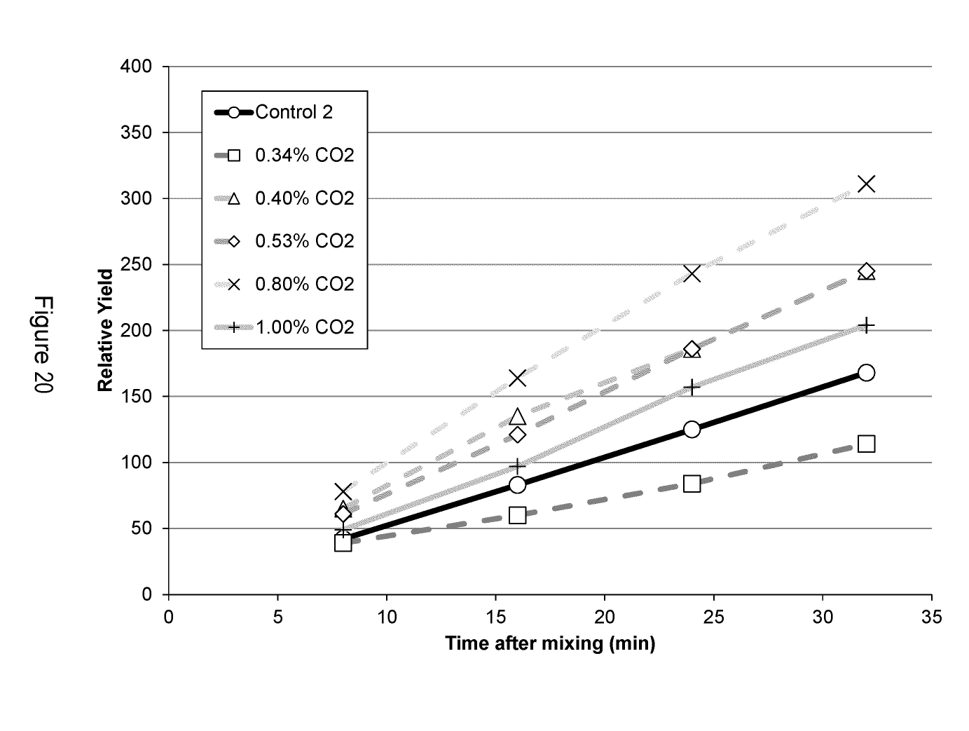

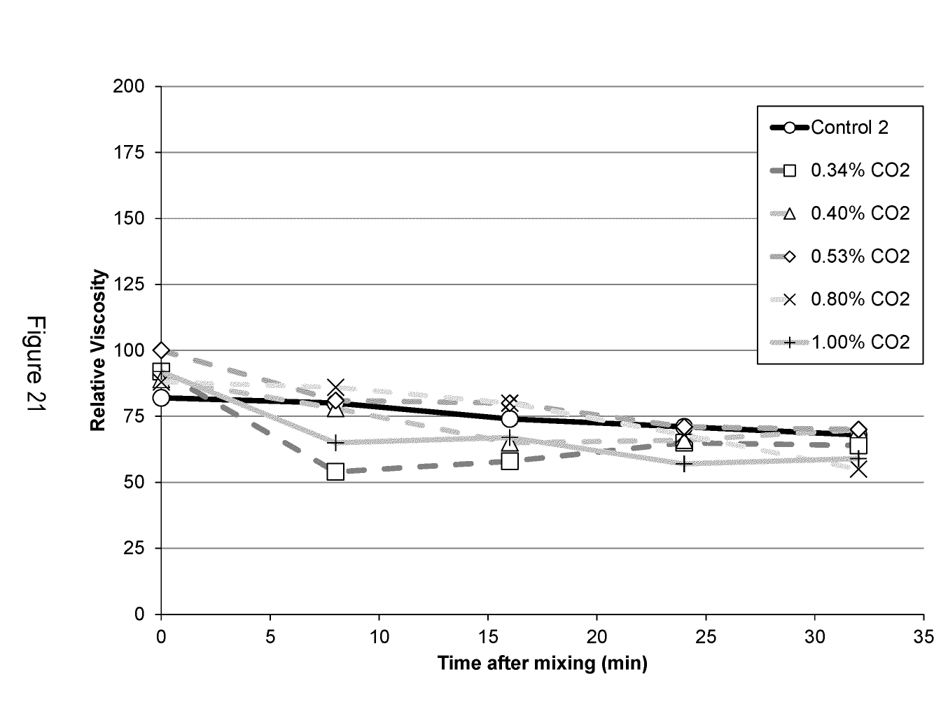

FIG. 19 shows that the lowest uptake seemed to reduce yield stress, while higher uptakes had yield stresses at 0 minutes that were very little changed from the uncarbonated control. However, the lowest uptake on this cement was much higher than in the previous test (0.34% in LAFB cement vs. 0.12% in STMB cement). FIG. 20 and TABLE 8 show yield stress relative to uncarbonated control, starting with the addition of the admixture and every 8 minutes thereafter, up to 32 minutes. Addition of admixture was less effective in reducing yield stress in the carbonated mortars compared to the uncarbonated control; in all cases except the lowest dose, the yield stress relative to control was higher after the admixture compared to before admixture (i.e., the admixture was more effective on the uncarbonated mortar). The stiffening rate was higher for all of the carbonated mortars except the lowest dose. As with the STMB cement mortar, the lowest dose reduced the stiffening rate. FIG. 21 shows that viscosity was relatively unchanged due to CO₂ addition and admixture addition.

TABLE 8
Rheology after addition of admixture, Lafarge Brookfield cement

| | | | | | Slope |
|---|---|---|---|---|---|
| | | CO₂ Uptake | Relative Yield | Slope after | relative |
| Batch | Condition | (% bwc) | @ 8 min | admix | to control |
| 1907 | Control | 0.00 | 100% | 5.3 | 100% |
| 1902 | CO₂ | 0.34 | 93% | 3.1 | 59% |
| 1903 | CO₂ | 0.53 | 145% | 7.7 | 147% |
| 1904 | CO₂ | 0.40 | 155% | 7.4 | 141% |
| 1905 | CO₂ | 1.00 | 117% | 6.6 | 125% |
| 1906 | CO₂ | 0.80 | 186% | 9.7 | 185% |

This Example demonstrates that carbonation and its effects on rheology are highly dependent on cement type, but that, in general, higher doses of carbonation increase stiffness and rate of stiffening while having much less effect on viscosity, especially at early time points.

### Example 9

This Example was a further demonstration of the large effect of carbonation of a cement mix, e.g. a mortar or a concrete, on stiffness and relatively small effect on viscosity, especially when vibration is used to assist flow.

Two identical mixes of cement paste were prepared, side by side, except that one was exposed to carbon dioxide while mixing (carbonated) and one was not. Each mix was poured into a slump test cone placed on a shallow plate (pie dish) and allowed to sit for 5 minutes. The cones were then removed. The uncarbonated cement paste showed a vertical drop of at least ¾ the height of the cone, with a spread at the base to at least twice the diameter of the cone. The carbonated cement was dramatically stiffer than the uncarbonated; when its cone was removed the vertical drop was about ⅓ the height of the cone, with virtually no spread at the base. The two samples were then placed on a vibrating plate. Both the carbonated and the uncarbonated cements collapsed and spread out in a liquid and flowable state on the pie plates, indicating that the vibration had effectively liquefied both mixes so that they were flowable; e.g., would easily conform to a mold.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of carbonating a wet concrete mix having a mix design and to be used in an operation to produce a carbonated wet concrete mix, wherein the carbonated concrete mix has a desired stiffness and/or rate of stiffening that is greater than a stiffness and/or rate of stiffening of an uncarbonated concrete mix of the same mix design, comprising contacting the wet concrete mix with a pre-determined dose of carbon dioxide during mixing, wherein the pre-determined dose of carbon dioxide is known or predicted to produce the desired stiffness and/or rate of stiffening under the conditions of the mixing and/or operation.

2. The method of claim 1 wherein the pre-determined dose is based on the mix design of the wet concrete mix.

3. The method of claim 2 wherein the pre-determined dose is based on the cement type in the mix design, one or more admixtures used in the mix design, or a combination thereof.

4. The method of claim 1 wherein the pre-determined dose is based on a test comprising
(i) contacting a first sample of the concrete mix or components of the concrete mix with a first test dose of carbon dioxide to produce a first test carbonated concrete mix or components of the concrete mix;
(ii) determining a stiffness and/or rate of stiffening of the first test carbonated concrete mix or components of the concrete mix; and
(iii) determining the pre-determined dose of carbon dioxide based at least in part on the first test dose and the stiffness and/or rate of stiffening of the first test carbonated concrete mix or components of the concrete mix.

5. The method of claim 4 wherein
step (i) further comprises contacting a second sample of the concrete mix or components of the concrete mix with a second test dose of carbon dioxide to produce a second test carbonated concrete mix or components of the concrete mix, wherein the second test dose is different from the first test dose;
step (ii) further comprises determining a stiffness and/or rate of stiffening of the second test carbonated concrete mix or components of the concrete mix; and
step (iii) comprises determining the pre-determined dose of carbon dioxide based at least in part on the first test dose and the stiffness and/or rate of stiffening of the first test carbonated concrete mix or components of the concrete mix and the second test dose and the stiffness and/or rate of stiffening of the second test carbonated concrete mix or components of the concrete mix.

6. The method of claim 4 wherein
step (i) further comprises contacting a third sample of the concrete mix or components of the concrete mix with a third test dose of carbon dioxide to produce a third test carbonated concrete mix or components of the concrete mix, wherein the third test dose is different from the first and second test doses;
step (ii) further comprises determining a stiffness and/or rate of stiffening of the third test carbonated concrete mix or components of the concrete mix; and
step (iii) comprises determining the pre-determined dose of carbon dioxide based at least in part on the first test dose and the stiffness and/or rate of stiffening of the first test carbonated concrete mix or components of the concrete mix, the second test dose and the stiffness and/or rate of stiffening of the second test carbonated concrete mix or components of the concrete mix, and the third test dose and the stiffness and/or rate of stiffening of the third test carbonated concrete mix or components of the concrete mix.

7. The method of any of the preceding claims wherein the pre-determined dose is also based, at least in part, on comparing an efficiency of carbonation of the test sample or samples to an expected efficiency of carbonation when the pre-determined dose is contacted with the wet concrete mix during mixing.

8. The method of any of the preceding claims wherein the stiffness or rate of stiffening of the carbonated concrete mix is at least 5% greater than that of the uncarbonated concrete mix.

9. The method of any of the preceding claims wherein the testing further comprises determining a stiffness and/or rate of stiffening of a sample of uncarbonated concrete mix, and comparing the stiffness and/or rate of stiffening of the carbonated samples to the uncarbonated sample.

10. The method of any of the preceding claims wherein the contacting of the test sample or samples with carbon dioxide is conducted at a temperature that is within 3° C. of the expected temperature at which the wet concrete mix will be contacted with the pre-determined dose of carbon dioxide.

11. The method of any of the preceding claims wherein the rate of stiffening is determined by measuring stiffness of the concrete mix at a plurality of time points, wherein the temperature at one or more of the plurality of time points is within 3° C. of the expected temperature at which the wet concrete mix will be used in the operation at the one or more time points.

12. The method of any of the preceding claims wherein the operation is a precast operation.

13. The method of any of the preceding claims wherein the operation is a slip form operation.

14. The method of any of the preceding claims wherein the operation is an operation in which concrete is poured into construction forms.

15. The method of any of the preceding claim wherein the operation is a 3D concrete printing operation.

16. A system comprising
(i) a concrete mixing facility in which a concrete mix is carbonated by contacting the mix with a pre-determined dose of carbon dioxide to produce a carbonated concrete mix that has a greater stiffness or rate of stiffening compared to the same concrete mix if it is not carbonated, where the concrete mix is for use in an operation;
(ii) a testing facility in which the pre-determined dose of carbon dioxide is determined; and
(iii) a communication system to communicate the pre-determined dose of carbon dioxide determined in the testing facility to the concrete mixing facility.

17. The system of claim 16 wherein the operation is a precast operation, a slip form operation, an operation in which concrete is poured into fixed forms, or a 3D concrete printing operation.

18. The system of claim 16 wherein the concrete mixing facility and the testing facility are different facilities.

19. The system of claim 16 wherein the concrete mixing facility comprises a concrete mixer and one or more sources of one or more concrete materials comprising one or more of cement, aggregate, and water.

20. The system of claim 16 wherein the test facility comprises a test concrete mixing apparatus, a carbon dioxide delivering and metering apparatus, and a concrete stiffness test apparatus.

21. The system of claim 20 wherein the test facility further comprises a concrete viscosity test apparatus.
